(19) United States
(12) Patent Application Publication
(10) Pub. No.: US 2016/0006605 A1
(43) Pub. Date: Jan. 7, 2016

(54) NETWORK CONTROL DEVICE AND NETWORK SETTING SYSTEM

(71) Applicant: Hitachi Metals, Ltd., Tokyo (JP)

(72) Inventors: Satoshi TSUTSUMI, Tokyo (JP); Koji WAKAYAMA, Tokyo (JP); Hitoshi KUWATA, Tokyo (JP)

(73) Assignee: HITACHI METALS, LTD., Tokyo (JP)

(21) Appl. No.: 14/752,326

(22) Filed: Jun. 26, 2015

(30) Foreign Application Priority Data
Jul. 3, 2014 (JP) 2014-137549

(51) Int. Cl. H04L 12/24

(52) U.S. Cl. CPC H04L 41/0803

(57) ABSTRACT

A typical network setting control device according to the present invention can be configured by a control device which includes an input device, an output device, a storage device, and a processing device and is connected to at least one communication device through a network. The control device performs network setting in the communication device on the basis of network setting data. The processing device creates a setting procedure of network setting. The setting procedure of the network setting is determined on the basis of the network setting data and an existing network configuration.

### CLAIM OF PRIORITY

The present application claims priority from Japanese application serial no. JP2014-137549, filed on Jul. 3, 2014, the content of which is hereby incorporated by reference into this application.

### BACKGROUND OF THE INVENTION

1. Field of the Invention

The present invention relates to a computer network field. More specifically, the present invention relates to a network setting control device and a network setting system which achieve a programmable network.

2. Description of the Related Art

In order to automatize network setting, a technique described in the following Japanese Unexamined Patent Publication No. 2012-44601 is present. In this publication, “a setting order creating unit creates setting order information for regulating an order of settings applied to a VPN terminal device and an aggregation virtual router” and “according to the order regulated by the setting order information, setting information to be set in the VPN terminal device and setting information to be set to the aggregation virtual router are applied to the VPN terminal device and the aggregation virtual router” are described.

### SUMMARY OF THE INVENTION

In a programmable network typified by SDN (Software Defined Networking), dynamic network building and optimization utilizing programmability can be achieved. In this technique, an automatized high-speed network configuration change is important.

In Japanese Unexamined Patent Publication No. 2012-44601, in order to automatize network setting, an aggregation virtual router serving as a host device determines a network setting procedure by a fixed order of a VPN terminal device or an order in which pieces of setting information are generated. However, a method of creating a setting order to prevent a failure from occurring in an existing network in a setting process is not described. Thus, in a network configuration different from that of Japanese Unexamined Patent Publication No. 2012-44601, a failure may occur in a setting process. For this reason, in the network setting process, a network service must be interrupted to make it impossible to achieve a high-speed network configuration change. A method of shortening a setting execution time is not described. When an amount of setting information is large, an interruption time of the network service disadvantageously becomes long.

Thus, it is an object of the present invention to provide a network setting control device and a network setting system which prevents a failure from occurring in an existing network in a setting procedure, creates a setting procedure which can shorten a setting execution time, and makes it possible to achieve high-speed setting execution.

In order to solve the above object, a typical network setting control device according to the present invention includes an input device, an output device, a storage device, and a processing device, and is configured by a control device connected to at least one communication device through a network. The control device performs network setting to the communication device on the basis of network setting data. The processing device creates a setting procedure for network setting. The setting procedure for network setting is determined on the basis of network setting data and an existing network configuration.

The setting procedure for network setting is preferably divided into a setting order in units of communication devices and a setting order in a communication device. Preferably, the setting order in a communication device is determined on the basis of an inclusive relation between settings (for example, matching conditions) included in the network setting data.

Preferably, of setting procedures of a plurality of created new network settings, a setting procedure which does not conflict with set network setting data is selected. More preferably, a storage destination (which is in a communication device) of a setting included in the network setting data is detected, and a setting procedure is created such that a plurality of settings included in the new network setting can be simultaneously performed to different storage destinations. Preferably, a setting order in units of communication devices, when a transmission side and a reception side of data are defined as upstream and downstream sides, respectively, is set from the downstream side.

Another aspect of the present invention is a system including at least one communication device connected to the control device through a network or a method using the system.

According to the present invention, a high-speed network configuration change can be achieved.

Problems, configurations, and advantages except for those described above will be cleared by the explanation of the following embodiments.

### BRIEF DESCRIPTION OF THE DRAWINGS

FIG. 1 is a block diagram showing a configuration of a network setting system according to a first embodiment.

FIG. 2 is a block diagram showing an example of a network configured by applying the network setting system according to the first embodiment.

FIG. 3 is a table showing an example of network setting data according to the first embodiment.

FIG. 4A is a table showing an example of the network data according to the first embodiment.

FIG. 4B is a table showing the example of the network data according to the first embodiment (rest).

FIG. 5A is a table showing an example of the network configuration data according to the first embodiment.

FIG. 5B is a table showing the example of the network configuration data according to the first embodiment (rest).

FIG. 6 is a flow chart for explaining network building according to the first embodiment.

FIG. 7 is a flow chart of setting procedure determination in units of devices according to the first embodiment.

FIG. 8 is a table showing an initialized device setting adjacent list according to the first embodiment.

FIG. 9 is a table showing a device setting adjacent list in a state in which a setting procedure determination in units of devices is ended according to the first embodiment.

FIG. 10 is a flow chart of setting procedure determination in device according to the first embodiment.

FIG. 11 is a table showing an initialized flow entry adjacent list according to the first embodiment.

FIG. 12 is a flow chart for determining whether a flow entry of a variable E should be executed prior to a flow entry of a variable F when Table properties are different from each other according to the first embodiment.

FIG. 13 is a table showing an action priority table of flow entries according to the first embodiment.

FIG. 14 is a flow chart for determining whether the flow entry of the variable E should be executed prior to the flow entry of the variable F when Table properties are matched with each other according to the first embodiment.

FIG. 15 is a flow chart for explaining an inclusive relation between matching conditions according to the first embodiment.

FIG. 16 is a flow chart for checking whether the variable E is equal to the variable F according to the first embodiment.

FIG. 17 is a flow chart for checking whether the variable E and the variable F have an exclusive relation according to the first embodiment.

FIG. 18 is a flow chart for checking whether the variable E is included in the variable F according to the first embodiment.

FIG. 19 is a flow chart for checking whether the variable E includes the variable F according to the first embodiment.

FIG. 20 is a table showing an example of a flow entry adjacent list in a state a setting procedure determination step in device according to the first embodiment.

FIG. 21 is a flow chart for avoiding conflict with an existing setting of a network according to the first embodiment.

FIG. 22 is a flow chart of path unit setting procedure determination according to the first embodiment.

FIG. 23 is a flow chart of in-device setting procedure candidate creation according to the first embodiment.

FIG. 24 is a flow chart for creating a permutation in partial graph units according to the first embodiment.

FIG. 25 is a flow chart for extracting a partial graph according to the first embodiment.

FIG. 26 is a flow chart for creating a permutation according to the first embodiment.

FIG. 27 is a flow chart of conflict detection according to the first embodiment.

FIG. 28 is a flow chart of loop detection according to the first embodiment.

FIG. 29 is a flow chart of setting destination dependence setting procedure determination according to the first embodiment.

FIG. 30 is a flow chart of in-device setting destination dependence setting procedure determination according to the first embodiment.

FIG. 31 is a table showing an example of a flow entry adjacent list after the in-device setting destination dependence setting procedure determination according to the first embodiment.

FIG. 32 is a flow chart of sequence number giving according to the first embodiment.

FIG. 33 is a flow chart of giving an in-device sequence number according to the first embodiment.

FIG. 34 is a flow chart of setting execution in a control device according to the first embodiment.

FIG. 35 is a flow chart of parallel execution of device setting according the first embodiment.

FIG. 36 is a flow chart of executing device setting according to the first embodiment.

FIG. 37 is a flow chart of parallel execution of flow entry setting according to the first embodiment.

FIG. 38 is a flow chart of setting request reception in the communication device according to el.

FIG. 39 is a flow chart of setting execution in the communication device according to the first embodiment.

FIG. 40 is a flow chart of setting execution in a setting execution unit according to the first embodiment.

FIG. 41 is a time line chart showing an example of a flow of network configuration change according to the first embodiment.

FIG. 42 is a block diagram showing a configuration of a network setting system according to a second embodiment.

FIG. 43 is a flow chart of setting execution in a control device according to the second embodiment.

### DETAILED DESCRIPTION OF THE PREFERRED EMBODIMENTS

Embodiments of the present invention will be described below with reference to the accompanying drawings. The same reference symbols in the drawings denote the same things or equivalents. For descriptive convenience, suffixes are added to symbols to discriminate the things from each other.

The present invention should not be interpreted to be limited to the contents described in the embodiments (will be described later). It can be easily understood by persons skilled in the art that changes and modifications of concrete configurations of the present invention can effect without departing from the spirit and scope of the invention. Expressions such as “first”, “second”, and “third” in the specification or the like are given to discriminate constituent elements from each other, do not always limit the number of constituent elements or an order of the constituent elements.

In the drawings or the like, the position, size, shape, range, and the like of each component may not show an actual position, an actual size, an actual shape, an actual range, and the like, respectively, to make it easy to understand the invention. For this reason, the present invention is not always limited to positions, sizes, shapes, ranges, and the like disclosed in the drawings or the like.

Issues, patents, and patent applications cited in the specification directly configure a part of explanation of the specification.

### First Embodiment

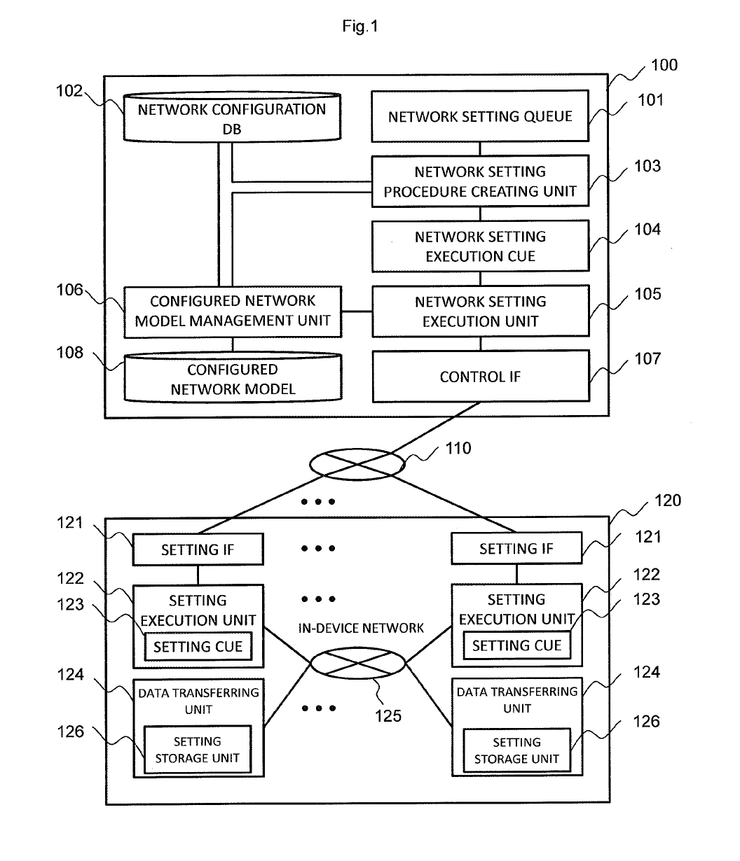

FIG. 1 is a block diagram showing a configuration of a network setting system according to an embodiment of the present invention.

A programmable network according to the embodiment includes a control device 100 and at least one communication device 120 which are connected to each other through a configuration network 110. The number of control devices 100 and the number of communication devices 120 are not limited to the numbers in the embodiment.

The control device 100 includes a network setting queue 101, a network configuration DB 102, a network setting procedure creating unit 103, a network setting execution queue 104, a network setting execution unit 105, a configured network model management unit 106, a control IF 107, and a configured network model 108. The control device 100 has an output device for outputting information and an input device for inputting information. It is assumed that the output device and the input device are included in the control IF 107.

The control device 100 can be achieved by using a general-purpose PC server or the like. In this case, the network setting queue 101, the network configuration DB 102, the network setting execution queue 104, and the configured network model 108 are stored in a semiconductor memory DRAM (Dynamic Random Access Memory), an SRAM (Static Random Access Memory), or the like. The network setting procedure creating unit 103, the network setting execution unit 105, and the configured network model management unit 106 are achieved as programs executed by a computing unit such as a CPU (Central Processing Unit). Furthermore, the units can also be achieved as hardware circuits such as an FPGA (Field Programmable Gate Array) and an ASIC (Application Specific Integrated Circuit).

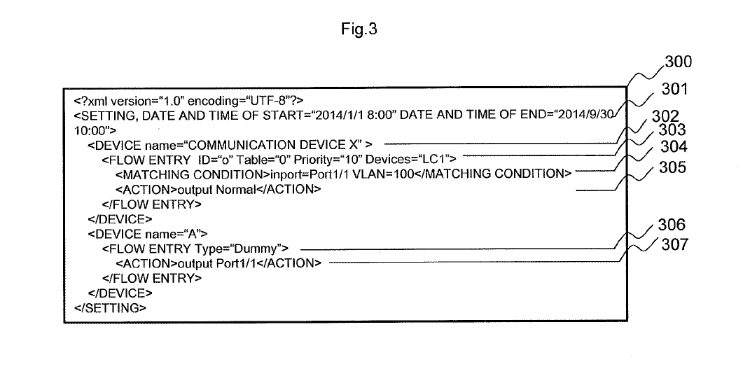

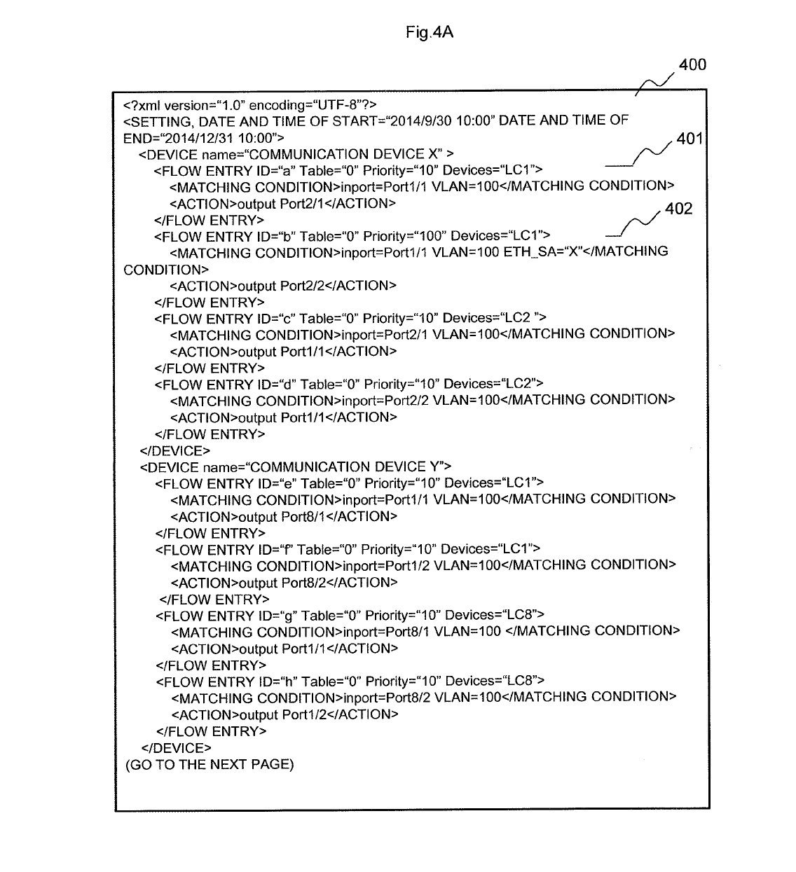

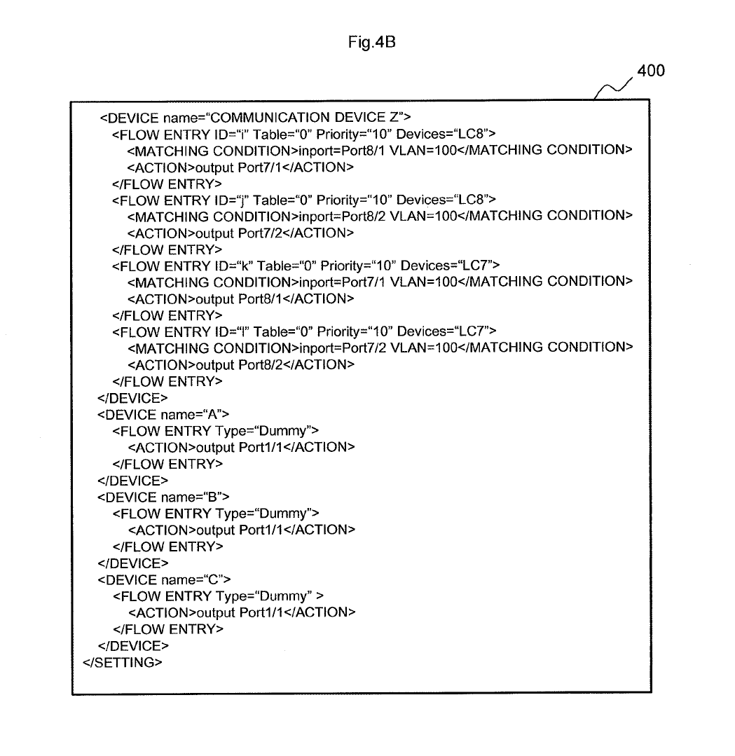

In the network setting queue 101, network setting data created by an operator is stored. The details of the network setting data will be described in FIG. 3 and FIG. 4.

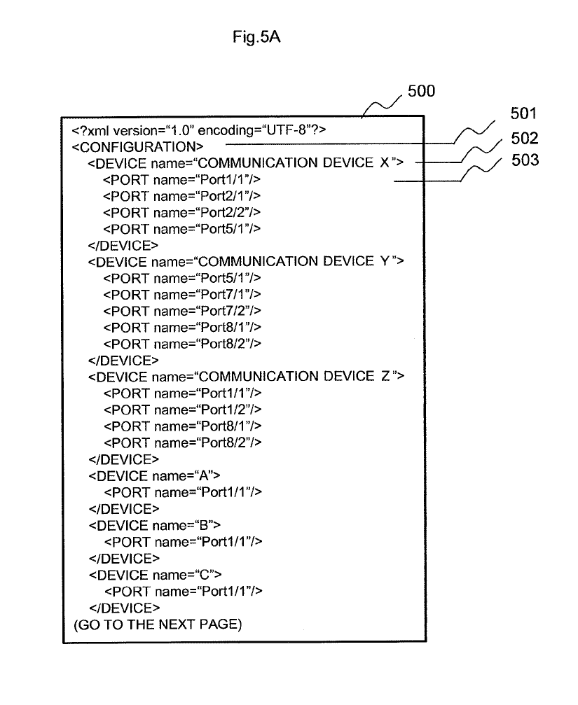

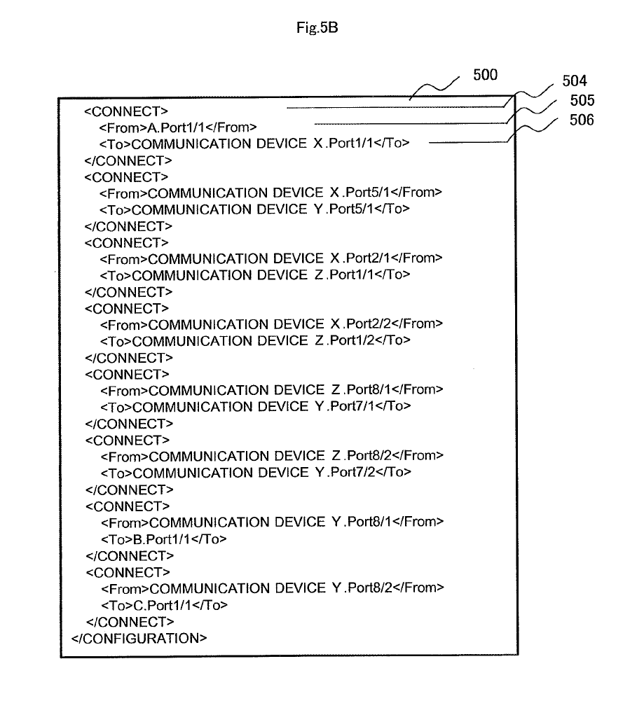

In the network configuration DB 102, a network configuration data created by an operator is stored. The details of the network setting data will be explained as an example in FIG. 5.

The network setting procedure creating unit 103 creates a network setting graph on the basis of the network setting data read from the network setting queue 101, the network configuration data read from the network configuration DB 102, and the configured network model 108. The network setting graph is a setting procedure of the network setting data. A setting procedure creating step and the network setting graph will be described later.

In the network setting execution queue 104, the network setting graph and the network setting data which are created by the network setting procedure creating unit are stored.

The network setting execution unit 105, when setting start time described in the network setting data comes, reads the network setting graph and the network setting data from the network setting execution queue. The network setting execution unit 105 sets the network setting data in the communication device 120 through the control IF 107 on the basis of the network setting graph, and notifies the configured network model management unit 106 of the same network setting data. The details of the network setting execution unit will be described later.

The configured network model management unit 106 creates and manages the configured network model 108. When the configured network model management unit 106 receives the notice of the network setting data from the network setting execution unit 105, the configured network model management unit 106 reflects the setting in the configured network model 108. The configured network model 108 is a data set which is obtained such that the communication devices 120 included in the network are modeled on the basis of the network configuration data and setting contents read from the network setting data which are set in the communication devices 120 are stored in the model.

The control IF 107 connects the control device 100 to the configuration network 110. The control IF 107 such as Ethernet (registered tradename) or Infiniband (registered tradename) needs only cause a control device and a communication device to communicate with each other. The control IF 107 needs only be connected to the configuration network 110, and is not limited in number. However, the number of control IFs 107 is increased to make it possible to improve a bottleneck problem in a network bandwidth.

The configured network model 108 holds setting information of all the communication devices 120 which are operated at present and connection relations between the communication devices. The details of the configured network model 108 will be described later.

In the embodiment, the numbers of requests and responses of the network can be advantageously reduced. For this reason, when a network delay increases, the advantage of the embodiment is also enhanced. For this reason, in the embodiment, as an example of the configuration network 110, a long-delay WAN (wide Area Network) is supposed. However, the WAN may be replaced with another communication means such as a wireless LAN (Local Area Network) such as IEEE802.11 (registered tradename) a/b/c and a LAN achieved by Ethernet (registered tradename). When the other communication means is used, a communication speed, the degree of freedom of arrangement, and the like can be improved.

In the embodiment, the network setting procedure creating unit 103 and the network setting execution unit 105 are included in the same control device. However, the network setting procedure creating unit 103 and the network setting execution unit 105 may be configured as different control devices and exchange necessary data through a network such as a LAN. A storage device which stores the network setting queue 101, the network configuration DB 102, the network setting execution queue 104, the configured network model 108, and the like therein may be arranged outside the control device.

The communication device 120 includes at least one setting IF 121, at least one setting execution unit 122, at least one data transferring unit 124, and an in-device network 125 which connects the setting execution unit 122 and the data transferring unit 124 to each other. The communication device 120, like an OpenFlow (registered tradename) switch or the like, can change data transferring processes with setting data.

The setting IF 121 connects the communication device 120 and the configuration network 110 to each other. The setting IF 121 needs only cause a control device and a communication device such as Ethernet (registered tradename) and Infiniband (registered tradename) to communicate with each other. In the embodiment, settings of the communication device 120 are executed in parallel with each other to advantageously shorten a setting change time. For this reason, in the embodiment, it is assumed that the communication device 120 includes the two or more setting IFs 121. The setting IF 121 provides one physical IF as a plurality of logical IFs. The number of physical setting IFs 121 is increased to advantageously improve a bottleneck in network bandwidth. In a system in which a bottleneck in network bandwidth is not posed as a problem, the number of setting IFs 121 may be one.

The setting execution unit 122 receives a setting request from the control device 100 to execute a setting in the data transferring unit 124. The setting request from the control device 100 is temporarily stored in a setting queue 123. The setting execution unit 122 is achieved as a program executed by a computing unit such as a CPU, or achieved as a logical circuit or the like implemented on an FPGA or the like. The setting queue 123, a semiconductor memory such as a DRAM or an SRAM may be used. A setting execution step will be described later.

The data transferring unit 124 performs data transferring of the communication device 120 on the basis of setting data stored in a setting storage unit 126. The data transferring unit 124 is achieved as a program executed by a computing unit such as a CPU, or a hardware circuit such as an FPGA or an ASIC.

The in-device network 125 connects the setting execution unit 122 and the data transferring unit 124 to each other. As the in-device network 125 according to the embodiment, a LAN using an electric backplane is supposed. However, the in-device network 125 may be an optical backplane or a wireless system without being limited to the embodiment.

As the setting storage unit 126, a semiconductor memory such as a DRAM, an SRAM, a TCAM (Ternary Content Addressable Memory), or the like may be used. In the embodiment, it is supposed that the setting storage unit 126, like an OpenFlow (registered tradename) flow table, includes two or more setting storage regions.

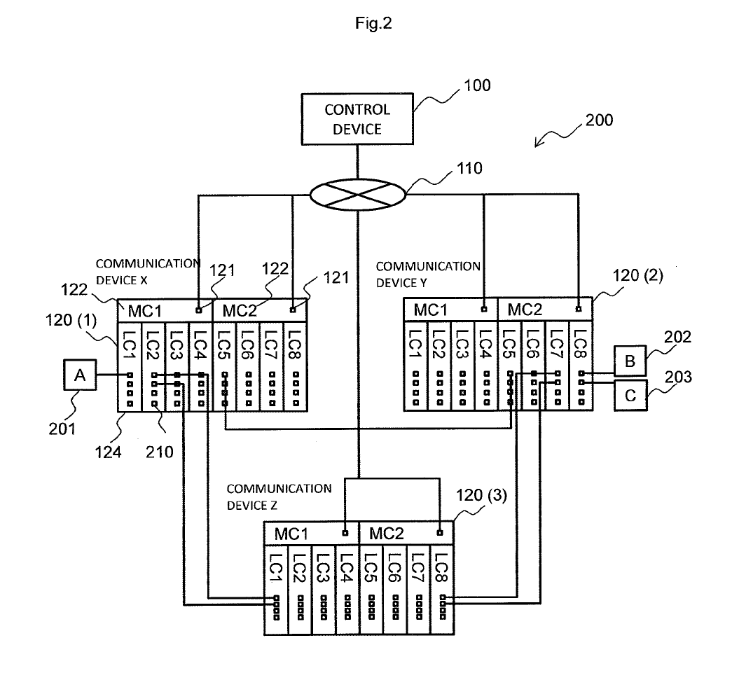

FIG. 2 shows an example of a network configured by applying the network setting system according to the first embodiment is applied. A network 200 includes a node A201, a node B202, a node C203, the control device 100, the configuration network 110, and a communication device X120(1) to a communication device Z120(3). As the node A201, the node B202, and the node C203, communication devices which are not managed by a terminal or the control device 100 are supposed.

In the embodiment, it is supposed that, as a protocol between the control device 100 and the communication device 120, OpenFlow (registered tradename) is used.

Each of the communication device X120(1) to the communication device 2120 (3) includes two MCs (Management Cards) serving as the setting execution units 122 and eight LCs (Line Cards) serving as the data transferring units 124. The LC includes four data transferring ports 210, and the MC includes the setting IF 121.

Subsequently, an mₜₕ (m is a natural number) port of the LCn (n is a natural number) is expressed as Port m/n. In the embodiment, node A is connected to Port 1/1 of the communication device X120(1), Port 1/2 of the communication device X120(1) is connected to Port 1/1 of the communication device Z120(3), Port 2/2 of the communication device X120(1) is connected to Port 2/1 of the communication device Z120(3), Port 5/1 of the communication device X120(1) is connected to Port 5/1 of the communication device Y120(2), Port 1/8 of the communication device Z120(3) is connected to Port 1/7 of the communication device Y120(2), Port 2/8 of the communication device 2120 (3) is connected to Port 2/7 of the communication device Y120(2), node B is connected to Port 1/8 of the communication device 120Y(2), and node C is connected to Port 2/8 of the communication device Y120(2).

FIG. 3 shows an example of network setting data stored in the network setting queue 101 in FIG. 1 and created by an operator. In the embodiment, network setting data 300 is described in XML (eXtensible Markup Language) format. The network setting data 300 may be described in a format except for XML format as long as the data includes equivalent data. The network setting data 300 defines setting of an entire network to be added or deleted.

A setting tag of a row 301 indicates a file in which network setting data is described, and an effective period of setting is designated by a start date and time property and an end date and time property.

A device tag of a row 302 specifies the communication device 120 to be set with a name property.

A flow entry tag of a row 303 designates setting contents stored in the setting storage unit 126 of the target communication device 120. As an ID property of the row 303, a unique value for designating a flow entry is designated. As a Table property, a value for specifying the plurality of setting storage units (tables) 126 is designated. A Priority tag designates priorities of flow entries. A Devices property designates a value for specifying an LC serving as the data transferring unit 124. In this manner, a storage destination (for example, a flow table) of a setting (for example, a flow entry) included in the setting data in the communication device is specified. In a typical example, the setting includes a condition (matching condition) of a frame to be processed and processing contents of a frame which satisfies the condition.

A matching condition tag of a row 304 designates a condition of a frame to which a data transferring process is to be applied. In the example of the row 304, a frame using Port 1/1 as an input port and using 100 as a VLAN is a target.

An action tag of a row 305 designates processing contents a frame which satisfies the matching condition. In the example of the row 305, an output destination Normal is designated. According to the specification of OpenFlow (registered tradename), an implementation-dependent operation in the communication device is performed. In the embodiment, when the output destination is Normal, like an L2 switch, a transferring operation based on an FDB (Forwarding DataBase) is supposed.

A row 306 indicates a flow entry of the node A201. Since a node A is a communication device which is not managed by a terminal or the control device 100, Dummy is designated as a Type property of the row 306, and a temporary flow entry having Port 1/1 as an output destination in a row 307 is designated. The above-mentioned tags will not be described below.

FIG. 4A and FIG. 4B show examples of network setting data stored in the network setting queue 101. Network setting data 400 includes flow entry tags 401 and 402.

FIG. 5A and 5B show examples of network configuration data stored in the network configuration DB 102 in FIG. 1. Although the network configuration data is described in XML format like the network setting data, the network configuration data may be described in a format except for XML format as long as the data includes equivalent data.

Network configuration data 500 defines physical configuration information of a network.

A configuration tag of a row 501 indicates a file in which network configuration data is described.

A device tag of a row 502 designates a device included in the network as a name property.

A port tag of a row 503 designates a port included in a device with a name property.

A connection tag of a row 504 designates a connection relation between devices.

A From tag of a row 505 indicates a connection source, and a To tag of a row 506 indicates a connection destination.

An outline of an operation of a programmable network according to the embodiment will be described below. A network building step will be described first by exemplifying an operation of adding the network setting data 400 (see FIG. 4) to the network 200 (see FIG. 2).

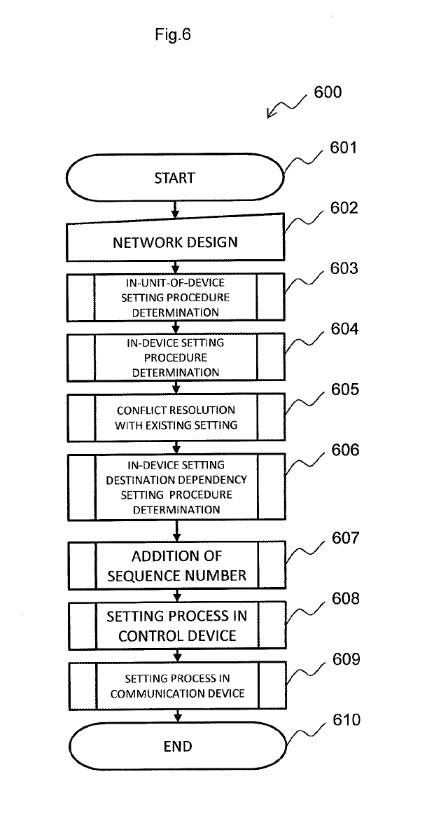

FIG. 6 is a flow chart 600 for explaining network building in the embodiment. The flow chart is executed by the network setting procedure creating unit 103 in FIG. 1.

The network building is started from a start state 601, and the process shifts to step 602.

In step 602, an operator creates the network configuration data 500 (see FIG. 5) on the basis of a physical network configuration to store the network configuration data 500 in the network configuration DB 102. The operator creates the network setting data 400 (see FIG. 4) serving as a logical network setting which satisfies user's requested specifications on the basis of the network configuration to store the network setting data 400 in the network setting queue 101. When the network setting data is stored in the network setting queue 101, the process shifts to step 603.

In step 603, the network setting procedure creating unit 103 of the control device 100 determines a setting procedure in units of devices and shifts to step 604.

In step 604, the network setting procedure creating unit 103 creates an in-device setting procedure on the basis of the network setting data and the network configuration data and shifts to step 605.

In step 605, on the basis of a configured network model, a setting procedure is created to prevent the network setting set in the network 200 from conflicting with the setting procedure created up to step 604, and the process shifts to step 606.

Step 606 is a process of determining a setting procedure determined depending on (based on) a setting destination in the device. In step 606, on the basis of information of the setting storage unit 126 described in the network setting data 400, setting procedures which can be simultaneously set in the different setting storage units 126, and the process shifts to step 607.

In step 607, sequence numbers are given to the setting procedures created up to step 606 in units of the communication devices 120, and the process shifts to step 608.

In step 608, the control device 100 starts a setting procedure and shifts to step 609. In step 609, the communication device 120 executes a setting procedure and shifts to step 610 and is ended.

As described above, the control device according to the embodiment includes the input device, the output device, the storage devices 102 and 108, and the processing device, and is connected to at least one communication device 120 through the configuration network 110. The control device, on the basis of the network setting data 300 input from the input device or stored in the storage device, performs network setting to the communication device. The processing device has the network setting procedure creating unit 103 which creates a setting procedure of the network setting, and the network setting procedure creating unit 103 has a function of detecting connection relations between the communication devices from the network configuration data 500 input from the input device or stored in the storage device. The processing device has a function of creating a setting order in units of communication devices on the basis of the detected connection relations and the network setting data to create a setting procedure of new network setting on the basis of a setting order in units of communication devices. In the embodiment, a network setting procedure is dynamically created on the basis of the existing network configuration and the network setting data. In this manner, a setting order which does no influence on the existing network configuration can be created.

Details of steps in the flow chart 600 will be described below.

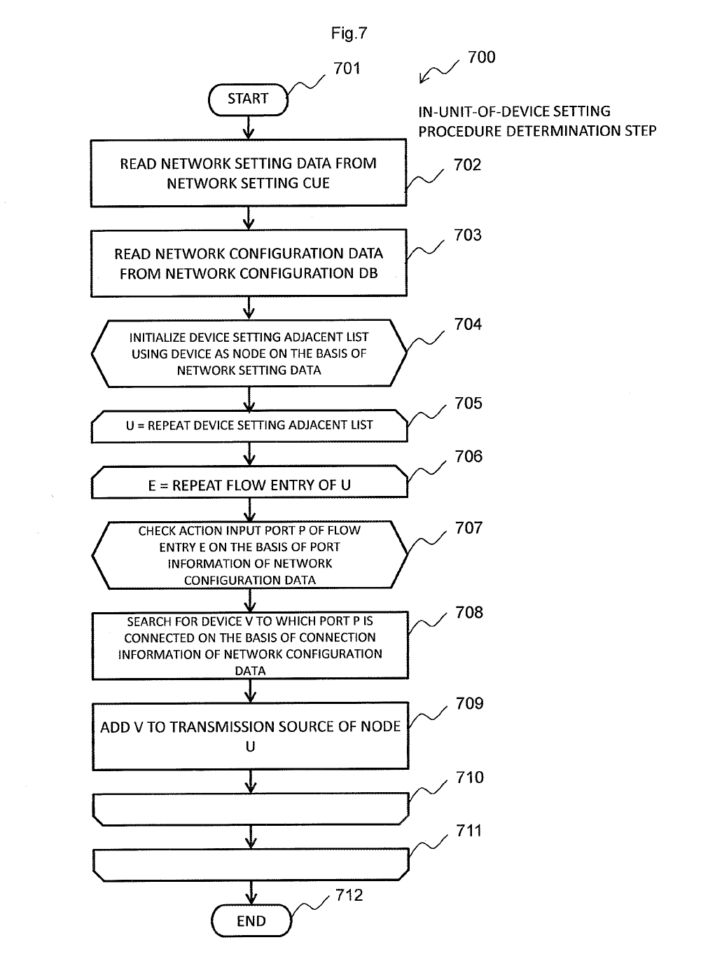

FIG. 7 is a flow chart 700 for explaining the details of an in-unit-of-device setting procedure determination step 603. The operation of the flow is started from a start state 701, and shifts to step 702.

In step 702, the network setting procedure creating unit 103 reads the network setting data 400 from the network setting queue 101 and shifts to step 703.

In step 703, the network setting procedure creating unit 103 reads the network configuration data 500 from the network configuration DB 102 and shifts to step 704. In step 704, the network setting procedure creating unit 103 initializes a device setting adjacent list using devices as graph nodes on the basis of the network setting data 400 and shifts to step 705.

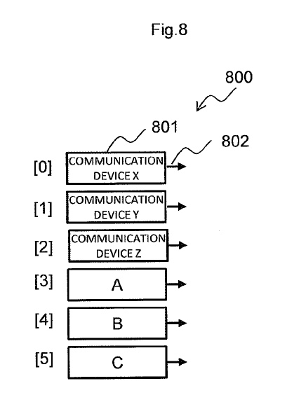

FIG. 8 is a device setting adjacent list 800 initialized in a device setting adjacent list initializing step 704 in FIG. 7. A “communication device X”, a “communication device Y”, a “communication device Z”, and the like for identifying a graph node 801 shown in FIG. 8 is the “device name” described in the network setting data 400 in FIG. 4. More specifically, the device setting adjacent list 800 is a graph in which a device defined by a device tag of the network setting data 400 is the graph node 801 and a connection state between devices is an edge 802. An initialized graph is a graph free from a connection state.

Returning to the flow chart 700, step 705 to step 711 are repetitive processing to the graph node 801 of the device setting adjacent list 800 in FIG. 8. More specifically, in this case, a variable U takes [0], [1], [2], [3], [4], and [5], and the processing is repeated for each graph node (device).

Step 706 to step 710 are repetitive processing to a flow entry corresponding to the graph node having the variable U and acquired from the network setting data 400. For example, it is understood from the network setting data 400 that flow entries corresponding to the graph node (communication device X) having

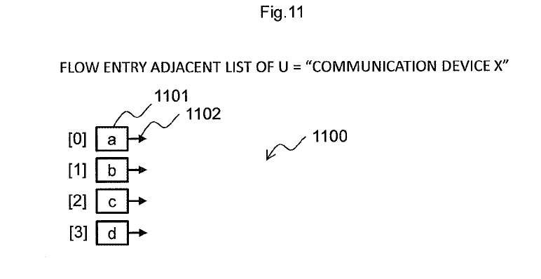

as the variable U in FIG. 8 are “a”, “b”, “c”, and “d”. Thus, a variable E takes [0], [1], [2], and [3] in FIG. 11, the processing is repeated for the flow entries.

In step 707, the network setting procedure creating unit 103 checks port information corresponding to the graph nodes having the variable U acquired from the network configuration data 500 with values (stored in a variable P) of inport which is an input port described as matching conditions of flow entries of the variable E and shifts to step 708. More specifically, in step 707, of the ports of the graphic nodes (devices) configuring the network, a port designated as an input port by the network configuration data 500 is extracted.

In step 708, the network setting procedure creating unit 103 searches the entries of the connection tags of the network configuration data 500 for a device (stored in a variable V) to which the port of the variable P is connected and shifts to step 709. In this manner, another device V connected to a port designated as an input port by the network configuration data 500 is extracted.

In step 709, the network setting procedure creating unit 103, on the basis of a setting procedure determination policy 713 in which a transmission source is set later, adds the variable V as a connection destination of the variable U of the device setting adjacent list 800 and shifts to step 710.

In step 710, the process shifts to step 711 when the repetitive processing is finished, and the process returns to step 706 when the repetitive processing is not finished.

In step 711, the process shifts to step 712 when the repetitive processing is finished, and the process returns to step 705 when the repetitive processing is not finished. Step 712 means an end state.

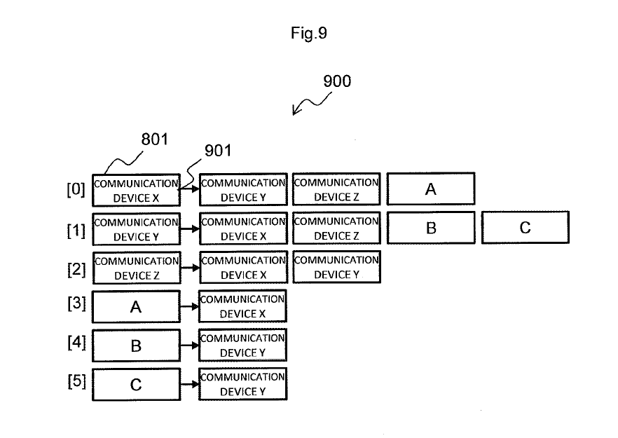

FIG. 9 is a device setting adjacent list 900 in a state in which the in-unit-of-device setting procedure determination step 700 is finished. Graph nodes written on the right of an edge 901 express a graph node list of connection sources of graph nodes on the left of the edge 901.

An in-unit-of-device setting procedure is executed on the basis of the device setting adjacent list 900. For example, the communication device X is set as a start position, the next is the communication device Y, the communication device Z, or A.

In this manner, according to the in-unit-of-device setting procedure determination step 700, a procedure of performing setting from the downstream of the network is created on the basis of the network setting data 400 and the network configuration data 500. When the setting is performed from the downstream of the network, unexpected inflowing of a packet can be prevented, and a network failure which may occur during setting can be avoided. In this case, a transmission side of data is called an upstream, and a reception side of data is called a downstream. More preferably, in the device setting adjacent list 900, since devices which are not connected are recognized to make it possible to safely set a plurality of devices in parallel, a setting execution time can be shortened.

The number of combinations of the in-unit-of-device setting procedures can be reduced to 12 in the example in FIG. 9, a setting procedure determination time can be shortened. When the in-unit-of-device setting procedure determination step 603 is not used, when the number of devices is n, the number of candidates of setting procedures is a factorial of n. For this reason, a setting procedure must be selected from 720 candidates in the network setting data 400.

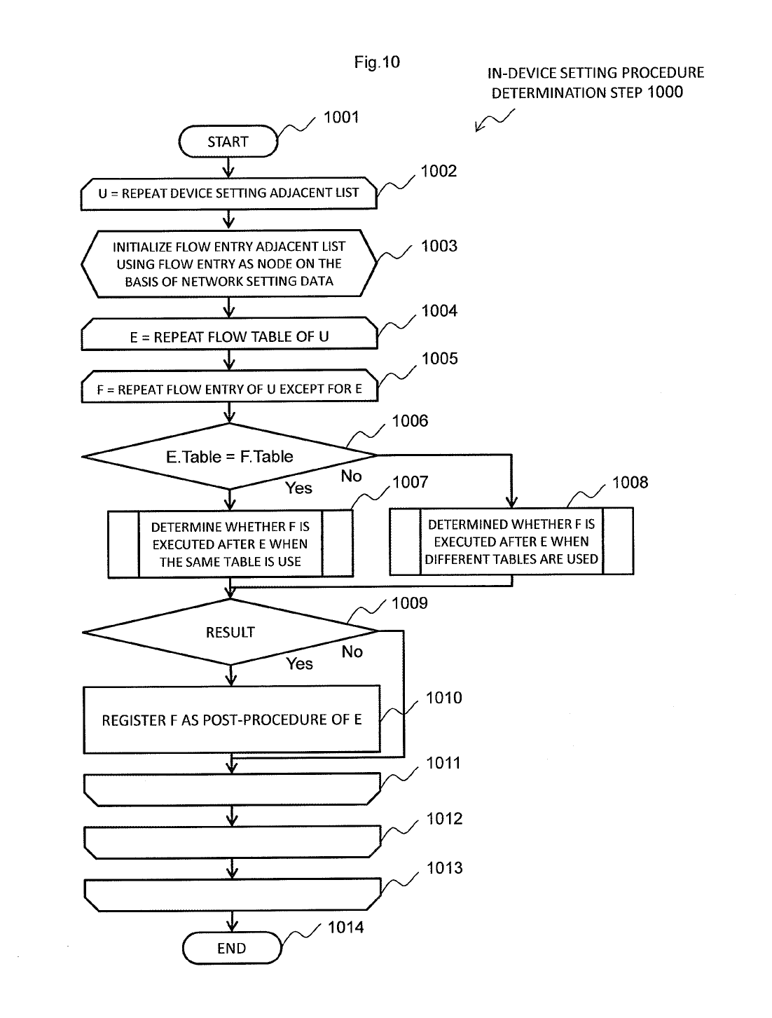

FIG. 10 is a flow chart 1000 for explaining details of an in-unit-of-device setting procedure determination step 604 in FIG. 6. The process of the flow is started from a start state 1001, and shifts to step 1002.

Step 1002 to step 1013 are repetition of the graph node 801 (stored in the variable U) of the device setting adjacent list 900.

In step 1003, the network setting procedure creating unit 103 initializes a flow entry adjacent list using the flow entry of the device having the variable U as a graph node on the basis of the network setting data 400 and shifts to step 1004.

FIG. 11 is a flow entry adjacent list 1100 initialized in a flow entry adjacent list initializing step 1003 in FIG. 10. Reference symbols “a”, “b”, “c”, and “d” for identifying a graph node 1101 shown in FIG. 11 is the flow entry ID described in the network setting data 400 in FIG. 4. The flow entry adjacent list 1100 is a graph in which a flow entry defined as a flow entry tag of the network setting data 400 and a setting procedure of a flow entry are expressed with the graph node 1101 and an edge 1102, respectively. An initialized graph is a graph in which an order of settings is not defined.

Returning to the flow chart 1000 in FIG. 10, step 1004 to step 1012 are repetition to (stored in the variable E) to the flow entry of the device having the variable U. Step 1005 to step 1011 are repetition to the flow entry of the device having the variable U except for the variable E. The variable E is excluded because a relation between the same devices need not be considered.

In step 1006, the network setting procedure creating unit 103 checks whether a Table property of the flow entry having the variable E is matched with a Table property of the flow entry having the variable F. The network setting procedure creating unit 103 shifts to step 1007 when Yes is determined and shifts to step 1008 when No is determined. This is because interference between the settings of the flow entries must be considered when the Table properties are matched with each other.

In step 1007, the network setting procedure creating unit 103 executes a flow chart 1200 (will be described later). When the Table properties are matched with each other, the network setting procedure creating unit 103 checks whether the flow entry of the variable F is executed after the flow entry of the variable E and shifts to step 1009.

In step 1008, the network setting procedure creating unit 103 executes a flow chart 1400 (will be described later). When the Table properties are different from each other, the network setting procedure creating unit 103 determines whether the flow entry of the variable F is executed after the flow entry of the variable E and shifts to step 1009.

In step 1009, the network setting procedure creating unit 103 checks a result in step 1007 or step 1008. The network setting procedure creating unit 103 shifts to step 1010 when Yes is determined and shifts to step 1011 when No is determined.

In step 1010, the network setting procedure creating unit 103 registers the flow entry of the variable F as a post-procedure of the flow entry of the variable E in the flow entry adjacent list and shifts to step 1011.

In step 1011, the process shifts to step 1012 when the repetitive processing is finished, and the process returns to step 1005 when the repetitive processing is not finished.

In step 1012, the process shifts to step 1013 when the repetitive processing is finished, and the process returns to step 1004 when the repetitive processing is not finished.

In step 1013, the process shifts to step 1014 when the repetitive processing is finished, and the process returns to step 1002 when the repetitive processing is not finished. Step 1014 is an end state.

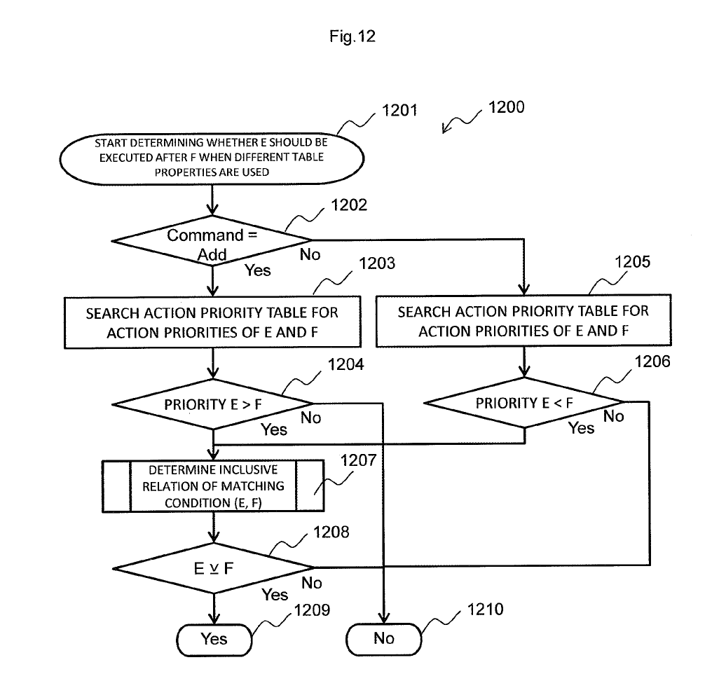

FIG. 12 is a flow chart 1200 for determining whether the flow entry of the variable E should be executed prior to the flow entry of the variable F when the Table properties are different from each other in determination step 1008 in FIG. 10. The process of the flow is started from a start state 1201, and shifts to step 1202.

In step 1202, the network setting procedure creating unit 103 determines whether a flow entry is added or deleted. The network setting procedure creating unit 103 shifts to step 1203 when Yes is determined and shifts to step 1205 when No is determined. Whether the flow entry is added or deleted may be determined by a method of using designation by an operator or a method in which the network setting procedure creating unit 103 determines addition before end time and deletion after the end time on the basis of an effective period of the network setting data 400.

In step 1203, the network setting procedure creating unit 103 searches an action priority table 1300 (will be described later) included in the network setting procedure creating unit 103 for action priorities of the flow entries of the variables E and F and shifts to step 1204.

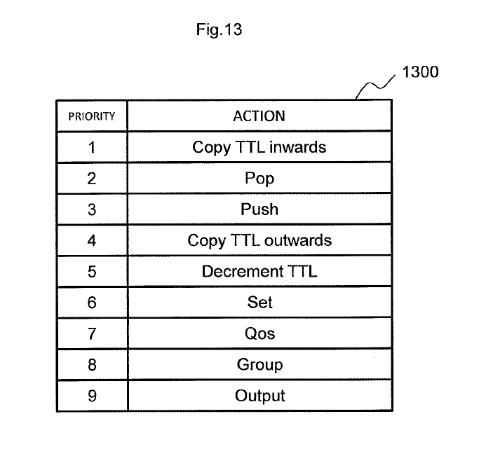

FIG. 13 is an action priority table of flow entries. This table is used in searching steps 1203 and 1205 in FIG. 12. In the action priority table, execution priorities of actions included in the flow entries are described. As the priorities, a method of storing values specified by OpenFlow (registered tradename) as fixed values in the network setting procedure creating unit 103, a method of setting arbitrary values by an operator, and the like are conceived.

Returning to a flow chart 1200 in FIG. 12, in step 1204, the network setting procedure creating unit 103 checks whether the action priority of the variable E is higher than the action priority of the variable F. The network setting procedure creating unit 103 shifts to step 1207 when Yes is determined and shifts to step 1210 when No is determined.

In step 1205, the network setting procedure creating unit 103 searches the action priority table 1300 (will be described later) included in the network setting procedure creating unit 103 for action priorities of the flow entries of the variables E and F and shifts to step 1206.

In step 1206, the network setting procedure creating unit 103 checks whether the action priority of the variable E is lower than the action priority of the variable F. The network setting procedure creating unit 103 shifts to step 1207 when Yes is determined and shifts to step 1210 when No is determined.

In step 1207, the network setting procedure creating unit 103 executes a flow chart 1500 (will be described later) to determine an inclusive relation of matching conditions of the flow entries of the variables E and F and shifts to step 1208.

In step 1208, the network setting procedure creating unit 103 checks whether a result in step 1207 is that “the variable E and the variable F have an exclusive relation”. The network setting procedure creating unit 103 shifts to step 1209 when Yes is determined and shifts to step 1210 when No is determined.

Yes is returned to a caller in step 1209, and No is returned to the caller in step 1210.

In this manner, in the flow chart 1200, when a setting procedure is determined on the basis of the action priorities, it can be secured that, before the data transferring unit 124 executes an action (output) of outputting a packet from a port, all the remaining actions to be executed are executed, and a network failure can be avoided during setting. Since it can be detected that the actions are forcibly executed in random order, shortening of a setting execution time can be achieved by parallelization.

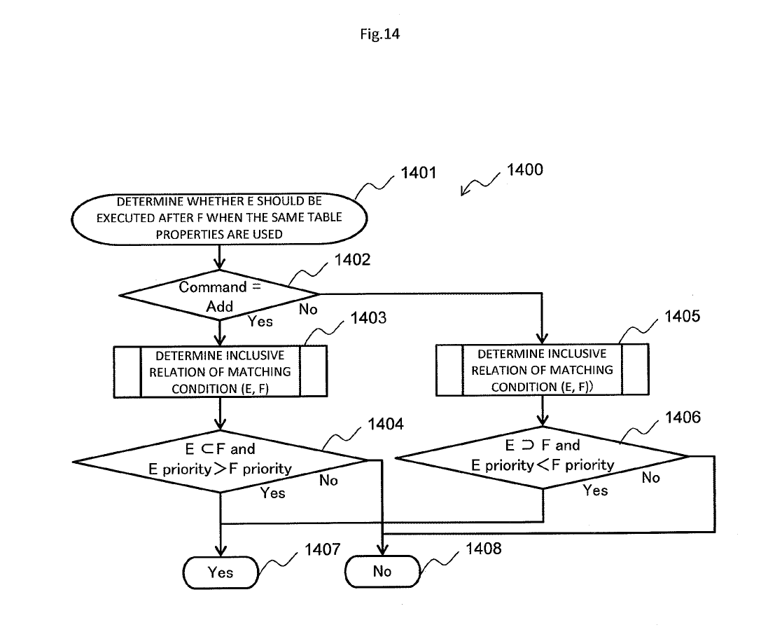

FIG. 14 is a flow chart 1400 for determining whether the flow entry of the variable E should be executed prior to the flow entry of the variable F when the Table properties are matched with each other in determination step 1007 in FIG. 10. First, the process is started from a start state 1401, and shifts to step 1402. In step 1402, the network setting procedure creating unit 103 determines whether a flow entry is added or deleted. The network setting procedure creating unit 103 shifts to step 1403 when Yes is determined and shifts to step 1405 when No is determined. Whether the flow entry is added or deleted may be determined by the same method as that in step 1202.

In step 1403, the network setting procedure creating unit 103 executes the flow chart 1500 (will be described later) to determine an inclusive relation of matching conditions of the flow entries of the variables E and F and shifts to step 1404. In step 1404, the network setting procedure creating unit 103 checks whether a result in step 1403 is that “the variable E is included in the variable F” and whether the Priority of the flow entry of the variable E is larger than the Priority of the flow entry of the variable F. The network setting procedure creating unit 103 shifts to step 1407 when Yes is determined and shifts to step 1408 when No is determined.

In step 1405, the network setting procedure creating unit 103 executes the flow chart 1500 (will be described later) to determine an inclusive relation of matching conditions of the flow entries of the variables E and F and shifts to step 1406. In step 1406, the network setting procedure creating unit 103 checks whether a result in step 1405 is that “the variable E includes the variable F” and whether the Priority of the flow entry of the variable E is lower than the Priority of the flow entry of the variable F. The network setting procedure creating unit 103 shifts to step 1407 when Yes is determined and shifts to step 1408 when No is determined. Yes is returned to the caller in step 1407, and No is returned to the caller in step 1408.

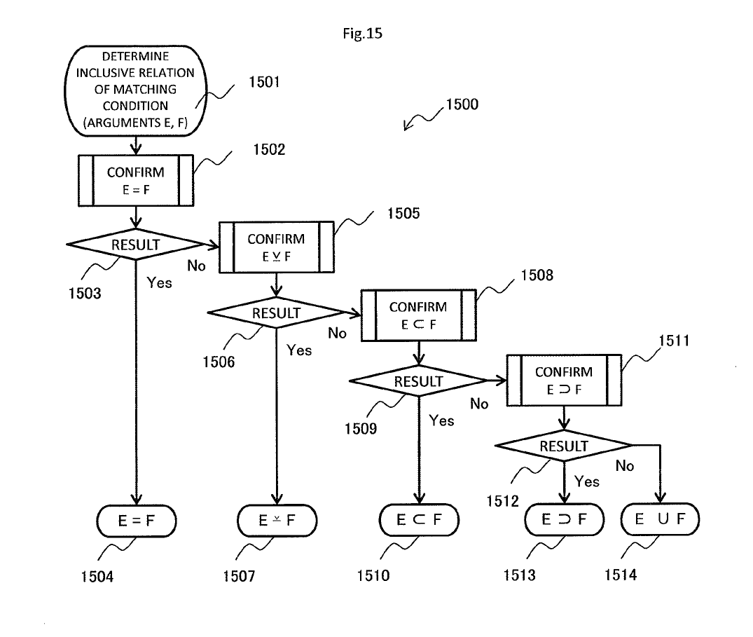

FIG. 15 is the flow chart 1500 for determining an inclusive relation between matching conditions in determination step 1207 in FIG. 12. The step of determining the inclusive relation between the matching conditions takes two flow entries E and F as arguments. The process is started from a start state 1501, and shifts to step 1502. In step 1502, the network setting procedure creating unit 103 executes a flow chart 1600 (will be described later) for checking whether “the variable E is equal to the variable F” and shifts to step 1503. In step 1503, the network setting procedure creating unit 103 checks a result in step 1502. The network setting procedure creating unit 103 shifts to step 1504 when Yes is determined and shifts to step 1503 when No is determined.

In step 1505, the network setting procedure creating unit 103 executes step 1700 of checking whether “the variable E and the variable F have an exclusive relation” and shifts to step 1506. In step 1506, the network setting procedure creating unit 103 checks a result in step 1505. The network setting procedure creating unit 103 shifts to step 1507 when Yes is determined and shifts to step 1508 when No is determined.

In step 1508, the network setting procedure creating unit 103 executes a flow chart 1800 for checking whether “the variable E is included in the variable F” and shifts to step 1509. In step 1509, the network setting procedure creating unit 103 checks a result in step 1508. The network setting procedure creating unit 103 shifts to step 1510 when Yes is determined and shifts to step 1511 when No is determined. In step 1511, the network setting procedure creating unit 103 executes a flow chart 1900 for checking whether “the variable E includes the variable F” and shifts to step 1512. In step 1512, the network setting procedure creating unit 103 checks a result in step 1511.

The network setting procedure creating unit 103 shifts step 1513 when Yes is determined and shifts to step 1514 when No is determined.

In step 1504, step 1507, step 1510, step 1513, and step 1514, “the variable E is equal to the variable F”, “the variable E and the variable F have an exclusive relation”, “the variable E is included in the variable F”, “the variable E includes the variable F”, and “the variable E and the variable F are compatible with each other are returned to callers, respectively.

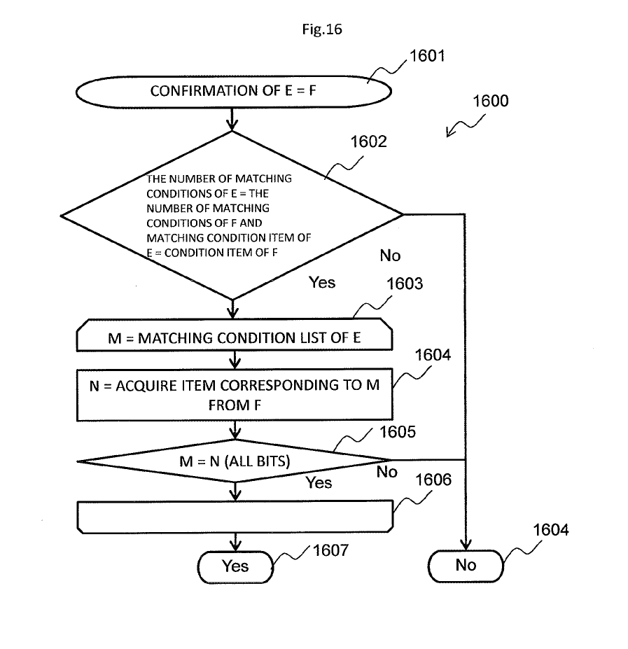

FIG. 16 is the flow chart 1600 for checking whether the variable E is equal to the variable F in the checking step 1502 in FIG. 15. First, the process is started from a start state 1601, and shifts to step 1602. In the step 1602, the network setting procedure creating unit 103 checks whether the number of matching conditions of the flow entries of the variable E is equal to the number of matching conditions of the flow entries of the variable F and a matching condition item of the flow entries of the variable E is equal to a matching condition item of the flow entries of the variable F. When the network setting procedure creating unit 103 shifts to step 1603 when Yes is determined and shifts to step 1604 when No is determined.

Step 1603 to step 1606 are repetition (stored in a variable M) for the matching conditions of the flow entries of the variable E. In step 1604, the network setting procedure creating unit 103 acquires a matching conditions corresponding to the items of the variable M from the matching conditions of the variable F (stored in a variable N) and shifts to step 1605. In step 1605, the network setting procedure creating unit 103 checks whether the variable M and the variable N have equal values. The network setting procedure creating unit 103 shifts to step 1606 when Yes is determined and shifts to step 1604 when No is determined. The network setting procedure creating unit 103 shifts to step 1607 when the repetitive processing is finished in step 1606, and returns to step 1603 when the repetitive processing is not finished. Yes is returned to the caller in step 1607, and No is returned to the caller in step 1604.

A result obtained in step 1600 means that the matching conditions of the variable E are completely equal to the matching conditions of the variable F.

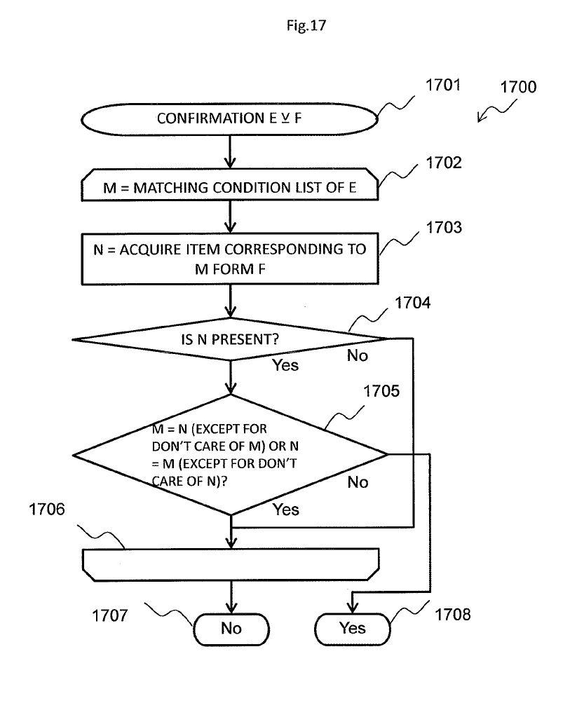

FIG. 17 is the flow chart 1700 for checking whether the variable E and the variable F have an exclusive relation in the checking step 1505 in FIG. 15. The process is started from a start state 1701, and shifts to step 1702. Step 1702 to step 1706 are repetition (stored in the variable M) for all the matching conditions of the flow entries of the variable E. In step 1703, the network setting procedure creating unit 103 acquires matching conditions corresponding to the items of the variable M from the matching conditions of the variable F (stored in the variable N) and shifts to step 1704. In step 1704, the network setting procedure creating unit 103 checks whether the variable N has a value. The network setting procedure creating unit 103 shifts to step 1705 when Yes is determined and shifts to step 1706 when No is determined.

In step 1705, the network setting procedure creating unit 103 checks whether all bits of the variable M except for Don't Care bits are equal to bits of the variable N (determines that the Don't Care bits of the variable N are constant) or all the bits of the variable N except for the Don't Care bits are equal to the bits of the variable M (determines that the Don't Care bits of the variable M are constant). The network setting procedure creating unit 103 shifts to step 1706 when Yes is determined and shifts to step 1708 when No is determined. The network setting procedure creating unit 103 shifts to step 1707 when the repetitive processing is finished in step 1706, and returns to step 1702 when the repetitive processing is not finished. No is returned to the caller in step 1707, and Yes is returned to the caller in step 1708.

A result obtained in step 1700 means that the matching conditions of the variable E and the matching conditions of the variable F are not compatible with each other.

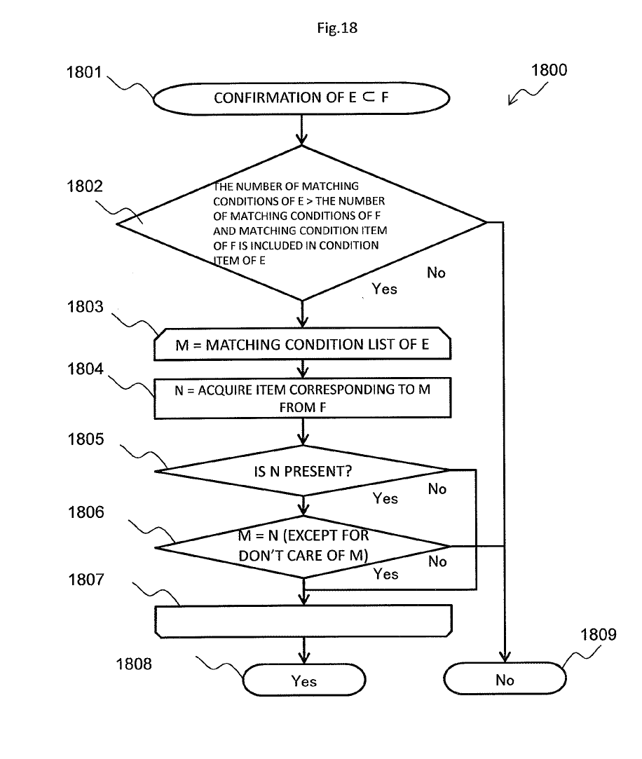

FIG. 18 is the flow chart 1800 for checking whether the variable E is included in the variable F. The process is started from a start state 1801, and shifts to step 1802. In step 1802, the network setting procedure creating unit 103 checks whether the number of matching conditions of the flow entries of the variable E is equal to or larger than the number of matching conditions of the flow entries of the variable F and all matching condition items of the flow entries of the variable F are included in matching condition items of the flow entries of the variable E. The network setting procedure creating unit 103 shifts to step 1803 when Yes is determined and shifts to step 1809 when No is determined. Step 1803 to step 1807 are repetitive processing (stored in the variable M) for all the matching conditions of the flow entries of the variable E.

In step 1804, the network setting procedure creating unit 103 acquires matching conditions corresponding to the items of the variable M from the matching conditions of the variable F (stored in the variable N) and shifts to step 1805. In step 1805, the network setting procedure creating unit 103 checks whether the variable N has a value. The network setting procedure creating unit 103 shifts to step 1806 when Yes is determined and shifts to step 1807 when No is determined.

In step 1806, the network setting procedure creating unit 103 checks whether all bits of the variable M except for Don't Care bits are equal to bits of the variable N (determines that the Don't Care bits of the variable N are constant). The network setting procedure creating unit 103 shifts to step 1807 when Yes is determined and shifts to step 1809 when No is determined. The network setting procedure creating unit 103 shifts to step 1808 when the repetitive processing is finished in step 1807, and returns to step 1803 when the repetitive processing is not finished. Yes is returned to the caller in step 1808, and No is returned to the caller in step 1809.

A result obtained in step 1800 means that the matching conditions equal to the matching conditions of the variable E are also equal to the matching conditions of the variable F (the reverse is not always true).

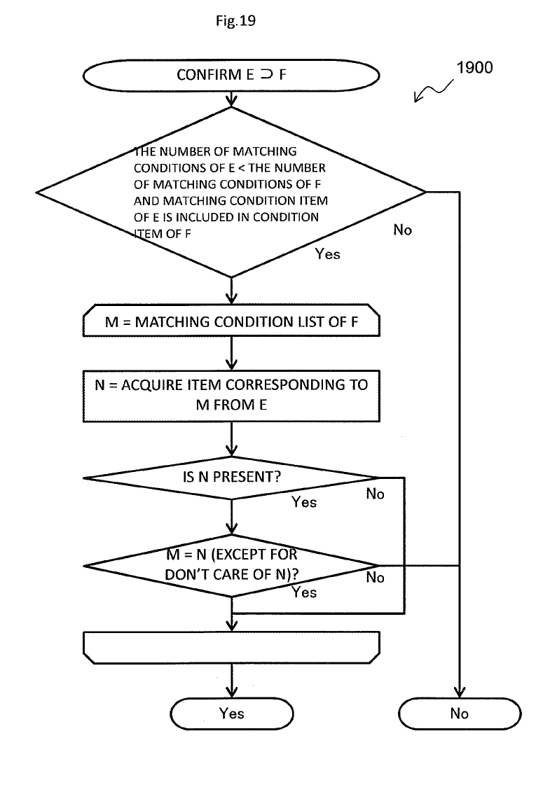

FIG. 19 is the flow chart 1900 for checking whether the variable E includes the variable F in checking step 1511 in FIG. 15. An execution result in the flow chart 1900 is the same as the result obtained by executing the variables E and F which are replaced with each other in the flow chart 1800.

The compatible relation between the variable E and the variable F means that the matching conditions of the variable E and the matching conditions of the variable F may be simultaneously satisfied.

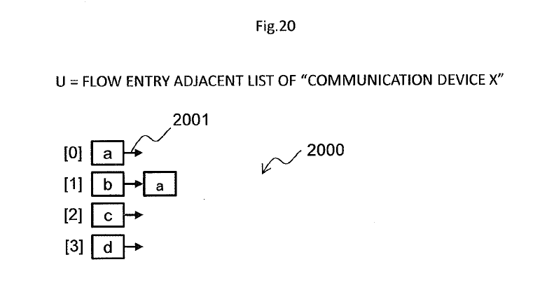

FIG. 20 shows an example of a flow entry adjacent list 2000 of a communication device X120(1) in a state in which the in-unit-of-device setting procedure determination step 1000 is started from an initial value of the initialized flow entry adjacent list 1100 (FIG. 11) and ended. Graph nodes written on the right of an edge 2001 are set after graph nodes on the left of the edge 2001.

As shown in FIG. 10 to FIG. 20, the network setting procedure creating unit 103 has a function of detecting an inclusive relation between settings included in the network setting data, and creates a setting procedure in a communication device on the basis of the detected inclusive relation. In this manner, when the setting procedure is determined on the basis of the inclusive relation of the matching conditions of the flow entries in the flow chart 1400, a procedure of preferentially setting a flow entry including a matching condition is created, and a network failure during setting can be avoided.

More specifically, in a conventional technique in which a setting procedure is fixed, a flow entry of an included matching condition may be preferentially set. When a packet which satisfies the included matching condition is input to the communication device 120, an action of the flow entry having the included matching condition is disadvantageously executed. However, in the embodiment, since a setting procedure is created such that an inclusive relation is checked, the problem can be solved.

When an exclusive flow entry relation which does not include an inclusive relation is identified, it can be detected that there is no forcible execution order. For this reason, a setting execution time can be shortened by parallelization.

In this manner, according to the in-device setting procedure determination flow chart 1000, on the basis of the network setting data 400, an in-device setting procedure which can shorten a setting execution time by parallelization of setting execution while a network failure is avoided.

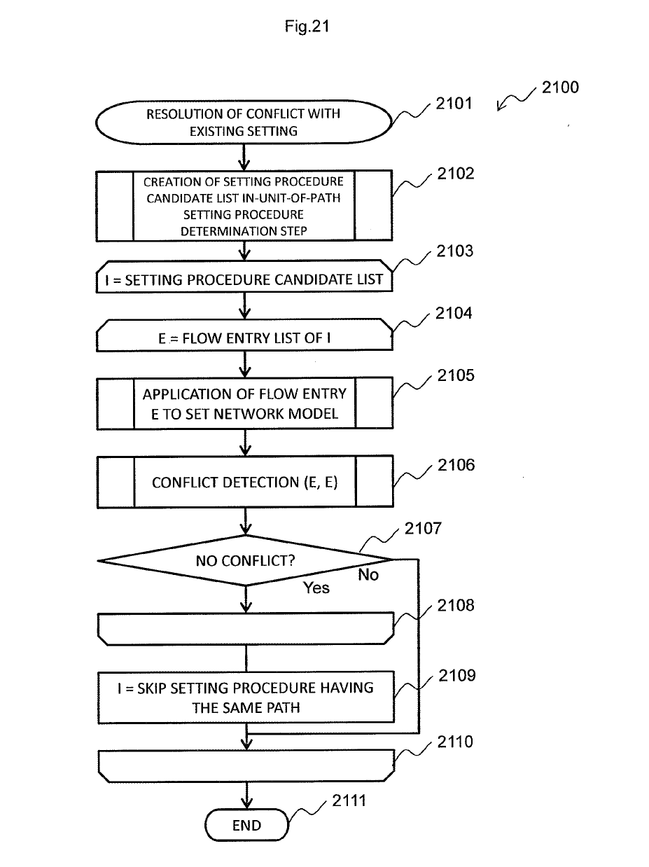

FIG. 21 is a flow chart 2100 for resolving conflict with an existing setting of the network 200 in the conflict resolution step 605 in FIG. 6. In the embodiment, settings which influence the existing setting during changing of network settings such as a setting which interrupts existing communication and a setting which disadvantageously forms a loop are defined as settings which conflict with the existing setting.

First, the process is started from a start state 2101, and shifts to step 2102. In step 2102, in an in-unit-of-path setting procedure determination flow chart 2200 (will be described later), the network setting procedure creating unit 103 creates a setting procedure candidate list and shifts to step 2103.

Step 2103 to step 2110 are repetitive (stored in a variable I) processing for all setting procedure candidate lists of the flow entries created in step 2102.

Steps 2104 to step 2108 are repetitive (stored in the variable E) processing for a flow entry list stored in the variable I. In step 2105, the network setting procedure creating unit 103 applies the flow entries of the variable E to the configured network model 108 acquired from the configured network model management unit 106 and shifts to step 2106.

In step 2106, the network setting procedure creating unit 103 execute conflict detection step 2700 (will be described later) and shifts to step 2107. It is checked in step 2107 whether a result in step 2106 conflicts with the existing setting. The network setting procedure creating unit 103 shifts to step 2108 when Yes is determined and shifts to step 2110 when No is determined.

In step 2108, the network setting procedure creating unit 103 shifts to step 2109 when the repetitive processing is finished and returns to step 2104 when the repetitive processing is not finished. In step 2109, the network setting procedure creating unit 103 skips, of the setting procedure candidate lists, a setting procedure candidate list having the same path as that of a communication path stored in the variable I at present (the variable I is updated) and shifts to step 2110. In step 2110, the network setting procedure creating unit 103 shifts to step 2111 when the repetitive processing is finished, and returns to step 2103 when the repetitive processing is not finished.

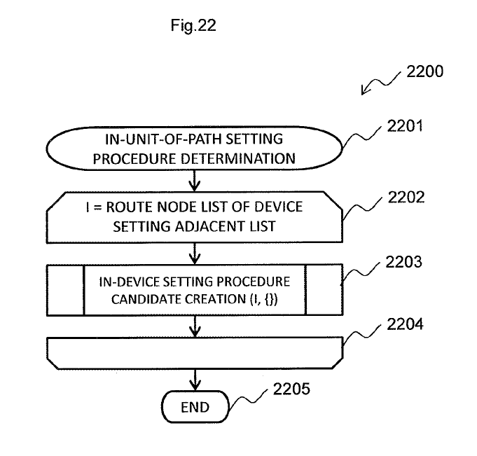

FIG. 22 is a flow chart 2200 of in-unit-of-path setting procedure determination 2102 in FIG. 21. The process is started from a start state 2201, and shifts to step 2202. Step 2202 to step 2204 are repetitive processing (stored in the variable I) for the device setting adjacent list 900 created by executing the flow chart 700. In step 2203, an in-device setting procedure candidate creating flow chart 2300 serving as a recursive step (will be described later) is executed, and the process shifts to step 2204. In step 2204, the process shifts to step 2205 when the repetitive processing is finished, and returns to step 2202 when the repetitive processing is finished.

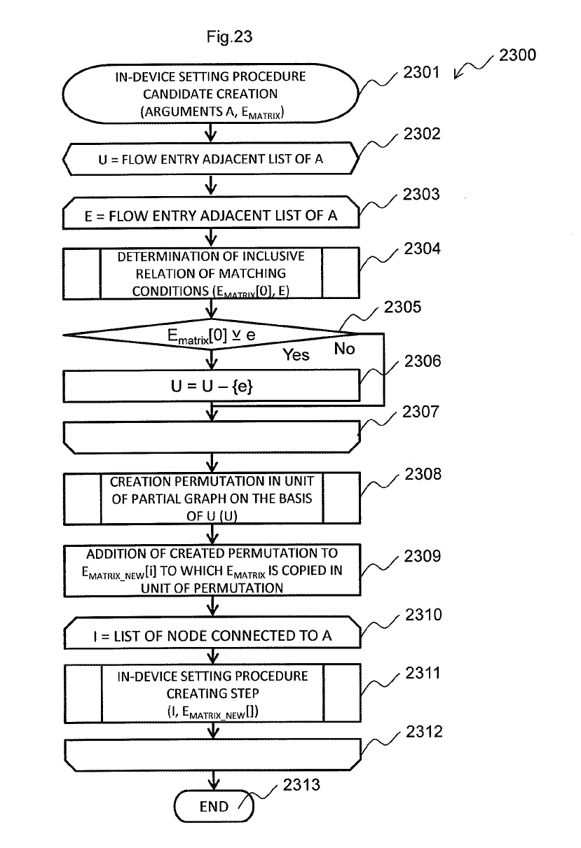

FIG. 23 is a flow chart 2300 of in-device setting procedure candidate creating step 2203 in FIG. 22. The in-device setting procedure candidate creating is a recursive process and takes a device A as an argument and takes a two-dimensional-array Ematrix in which the setting procedure candidate list is stored.

The process is started from a start state 2301, and shifts to step 2302. In step 2302, a flow entry adjacent list corresponding to the device A and created by the in-device setting procedure determination flow chart 1000 is stored in a variable U, and the process shifts to step 2303. Step 2303 to step 2307 are repetitive processing (stored in a variable e) for the flow entry adjacent list of the device A.

In step 2304, the Ematrix and the variable e are given as arguments, the flow chart 1500 for determining an inclusive relation of matching conditions is executed, and the process shifts to step 2305. It is checked in step 2305 whether a result in step 2304 is an exclusive relation. The process shifts to step 2306 when Yes is determined and shifts to step 2307 when No is determined. Elements of the variable e are removed from the variable U, and the process shifts to step 2307. In step 2307, the process shifts to step 2308 when the repetitive processing is finished, and returned to step 2303 when the repetitive processing is not finished.

In step 2308, a flow chart 2400 which creates permutations in units of partial graphs (will be described later) is executed, and the process shifts to step 2309. In step 2309, the created permutations are added to Ematrix new [i] (i is a suffix representing a number started from 0 and obtained by subtracting 1 from the number of permutations) obtained by copying the Ematrix i units of permutations, respectively, and the process shifts to step 2310. Step 2310 to step 2312 are repetitive processing (stored in the variable I) for a node connected to the device A acquired from the flow entry adjacent list 1100. In step 2311, the in-device setting procedure candidate creating step (arguments are the variable I and overall Ematrix_new [ ]) is executed again, and the process shifts to step 2312. Step 2313 is an end state.

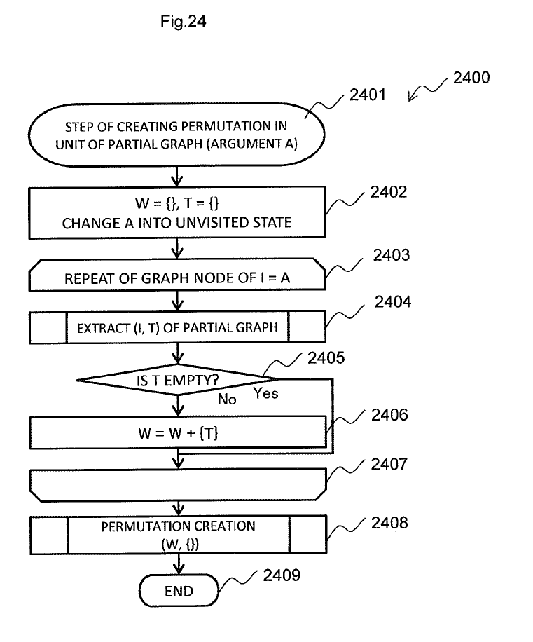

FIG. 24 is a flow chart 2400 of step 2308 of creating permutations in units of partial graphs in FIG. 23. The partial graph mentioned here means a set of graph nodes coupled at an edge where a setting procedure is forced in the flow entry adjacent list 900 (single graph node is regarded as a set of one graph node). The step of creating permutations in units of partial graphs takes a flow entry adjacent list A as an argument. The process is started from a stat state 2401, and shifts to step 2402. In step 2402, an array variable W and an array variable T are initialized into empty sets, and the process shifts to step 2403. Step 2403 to step 2407 are repetitive processing (stored in the variable I) for graph nodes in the flow entry adjacent list.

In step 2404, a flow chart 2500 of extracting a partial graph (will be described later) is executed, and the process shifts to step 2405. It is checked in step 2405 whether the array variable T is empty. The process shifts to step 2407 when Yes is determined and shifts to step 2406 when No is determined. In step 2406, the array variable T is added to the array variable W, and the process shifts to step 2407.

In step 2407, the process shifts to step 2408 when the repetitive processing is finished and shifts to step 2408 when the repetitive processing is not finished. In step 2408, a permutation creating flow chart 2600 (will be described later), and the process shifts to step 2409. Step 2409 is an end state.

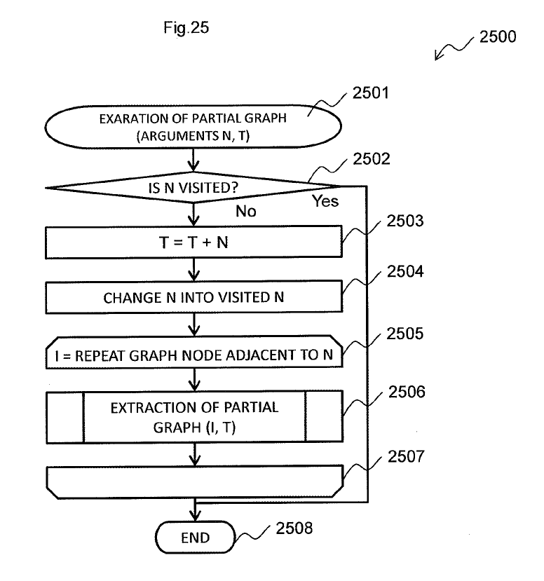

FIG. 25 is the flow chart 2500 of step 2404 of extracting a partial graph in FIG. 24. The step of extracting a partial graph is a recursive process, and takes a graph node N and an array T for storing a result as arguments. The process is started from a start state 2501, and shifts to step 2502. It is checked in step 2502 whether the graph node N is in a visit state. The process shifts to step 2508 when Yes is determined and shifts to step 2503 when No is determined. In step 2503, the graph node N is added to the array T, and the process shifts to step 2504. In step 2504, the state of the graph node N is changed into the visit state, and the process shifts to step 2505. Step 2505 to step 2507 are repetitive processing (stored in the variable I) for all adjacent graph nodes of the graph node N.

In step 2506, the partial graph extracting step is executed again by giving the variable I and the array T as arguments, and the process shifts to step 2507. In step 2507, the process shifts to step 2508 when the repetitive processing is finished and shifts to step 2508 when the repetitive processing is not finished. Step 2508 is an end state.

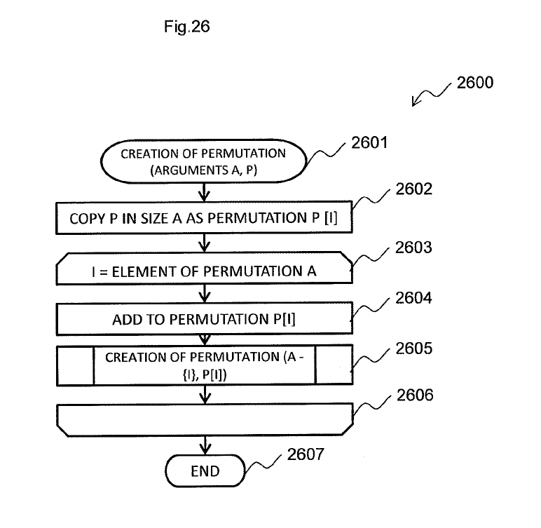

FIG. 26 is a flow chart 2600 of step 2408 of creating a permutation in FIG. 24. The permutation creating step is a recursive process, and takes, as arguments, an array A of partial graphs and an array P in which a result is stored. The process is started from a start state 2601, and shifts to step 2602. In step 2602, the array P is duplicated to form arrays P [i] (i is a suffix meaning an iₜₕ element) the size of which is equal to that of the array A, and the process shifts to step 2603. Step 2603 to step 2606 are repetitive processing (stored in the variable I) for elements of the array A.

In step 2604, the variable I is added to the arrays P [i], and the process is shifts to step 2605. In step 2605, the permutation creating step is executed by giving A-{I} and the arrays P [i] as arguments again, and the process shifts to step 2606. In Step 2606, the process shifts to step 2607 when the repetitive processing is finished, and returns to step 2603 when the repetitive processing is not finished. Step 2607 is an end state.

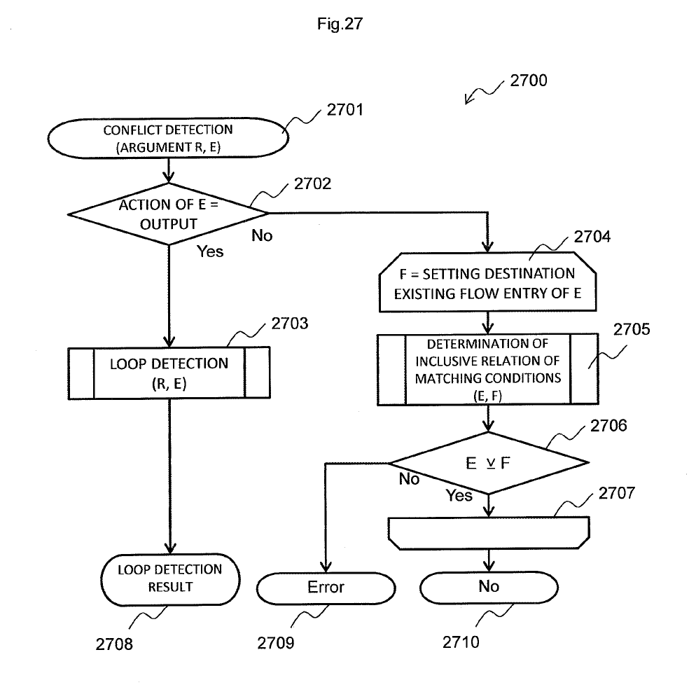

FIG. 27 is a flow chart 2700 of conflict detection step 2106 in FIG. 21. The conflict detection step takes a flow entry E as an argument. The process is started from a start state 2701, and shifts to step 2702. It is checked in step 2702 whether an action of the flow entry E is an output. The process shifts to step 2703 when Yes is determined and shifts to step 2704 when No is determined.

In step 2703, a loop detection flow chart 2800 (will be described later) is executed, and the process shifts to the step 2708. Step 2704 to step 2707 are repetitive processing (stored in the variable F) for a flow entry which has been set in a communication device in which the flow entry E is set. A setting destination of the flow entry E is acquired by searching the network setting data 400 on the basis of the ID property of the flow entry E. The flow entry which has been set in the setting destination is acquired from the configured network model 108.

In step 2705, the flow chart 1500 which designates E and F as arguments to determine an inclusive relation between matching conditions is executed, and the process shifts to step 2706. It is determined in step 2706 whether a result in step 2705 has an exclusive relation. The process shifts to step 2707 when Yes is determined and shifts to step 2709 when No is determined. In step 2707, the process shifts to step 2710 when the repetitive processing is finished, and returns to step 2704 when the repetitive processing is not finished.

In step 2708, the loop detection result in step 2703 is returned to a caller to end the process. In step 2709, Error representing that a conflict is detected is returned to the caller to end the process. In step 2710, No representing that a conflict is not detected is returned to the caller to end the process.

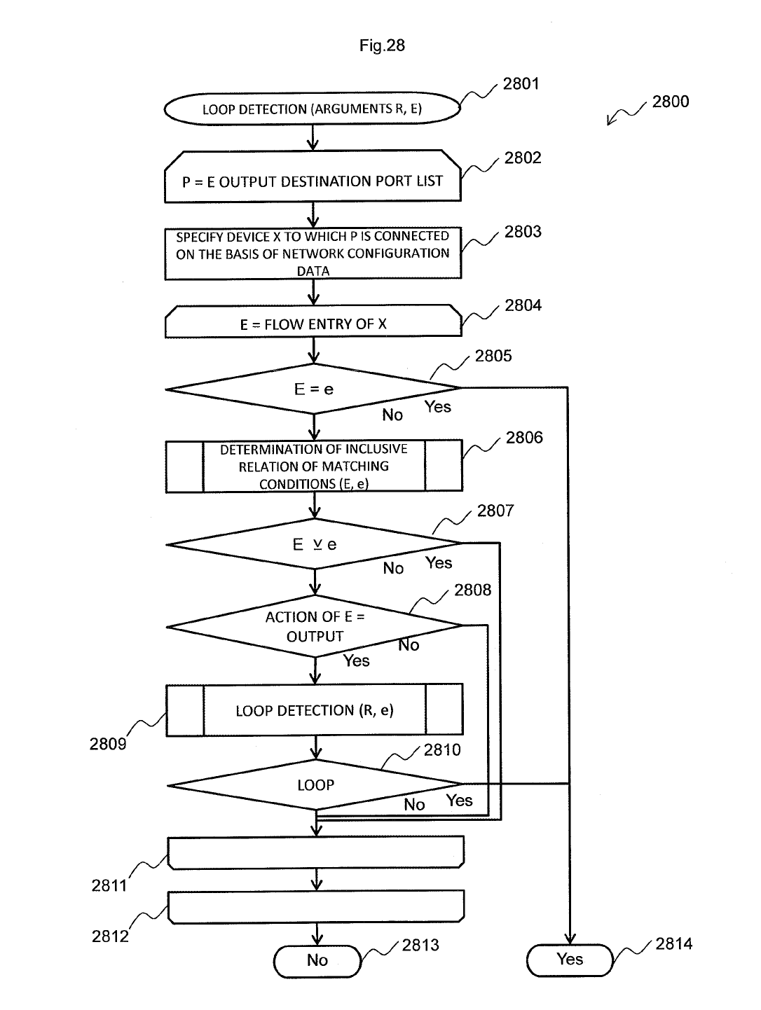

FIG. 28 is the flow chart 2800 of loop detection step 2703 in FIG. 27. The loop detection step is a recursive process, and takes a flow entry R and the flow entry E as arguments. The process is started from a start state 2801, and shifts to step 2802. Step 2802 to step 2812 are repetitive processing (stored in the variable P) for an output destination of the action output of the entry E. When the output destination is Normal, on the basis of the ID of the flow entry E, a setting destination device is specified on the basis of the network setting data, and an output port belonging to the same VLAN set in the device is acquired from the configured network model 108.

In step 2803, a device X to which the variable P is connected is specified on the network configuration data 500, and the process shifts to step 2804. Step 2804 to step 2811 are repetitive processing (variable e) for a flow entry set in the device X. The flow entry set in the device X is acquired from the configured network model 108. It is checked in step 2805 whether the flow entry E is the same as the flow entry e. The process shifts to step 2814 when Yes is determined and shifts to step 2806 when No is determined.

In step 2806, the flow chart 1500 which designates E and e as arguments to determine an inclusive relation between matching conditions is executed, and the process shifts to step 2807. It is checked in step 2807 whether a result in step 2806 has an exclusive relation. The process shifts to step 2808 when Yes is determined and shifts to step 2811 when No is determined.

It is checked in step 2808 whether the action of the flow entry e includes output. The process shifts to step 2809 when Yes is determined and shifts to step 2811 when No is determined. In step 2809, the flow entry R and the flow entry e are designated as arguments, the loop detection step is executed again, and the process shifts to step 2811.

In step 2811, the process shifts to step 2812 when the repetitive processing is finished, and returns to step 2804 when the repetitive processing is not finished. In step 2812, the process shifts to step 2813 when the repetitive processing is finished, and returns to step 2802 when the repetitive processing is not finished.

In step 2813, No is returned to the caller to end the process. In step 2814, Yes is returned to the caller to end the process.

As described in FIG. 21 to FIG. 28, the network setting procedure creating unit selects, of setting procedures of created new network settings, a setting procedure which does not conflict with set network setting data which is input from an input device or stored in a storage device.

More specifically, in the flow chart 2100, a setting procedure, the conflict of which is checked with an existing setting, is selected from setting procedure candidates to make it possible to avoid a loop during changing of network settings. Furthermore, conflicting setting contents which influence the existing setting can be detected, and changing of reliable network configurations can be achieved.

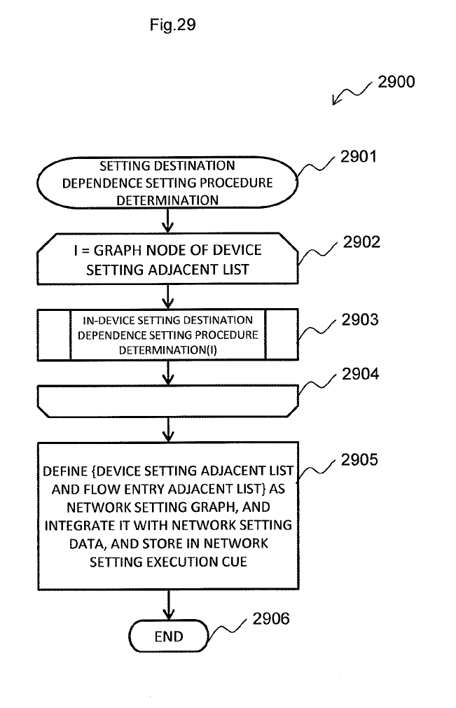

FIG. 29 is a flow chart 2900 of setting destination dependence setting procedure determination step 606 in FIG. 6. In this case, on the basis of the information of the setting storage unit 126 described in the network setting data 400, setting procedures which can be simultaneously set in the different setting storage units 126 are created. The process is started from a start state 2901, and shifts to step 2902.

Step 2902 to step 2904 are repetitive processing (stored in the variable I) for a graph node of the device setting adjacent list 900.

In step 2903, a flow chart 3000 of in-device setting destination dependence setting procedure determination is executed, and the process shifts to step 2904.

In step 2904, the process shifts to step 2905 when the repetitive processing is finished, and returns to step 2902 when the repetitive processing is not finished.

In step 2905, the device setting adjacent list 900 and the flow entry adjacent list created by a flow chart 2900 (will be described later) are integrated with each other as a network setting graph, and the network setting graph is stored in the network setting execution queue 104 together with the network setting data 400, and the process shifts to step 2906. Step 2906 is an end state.

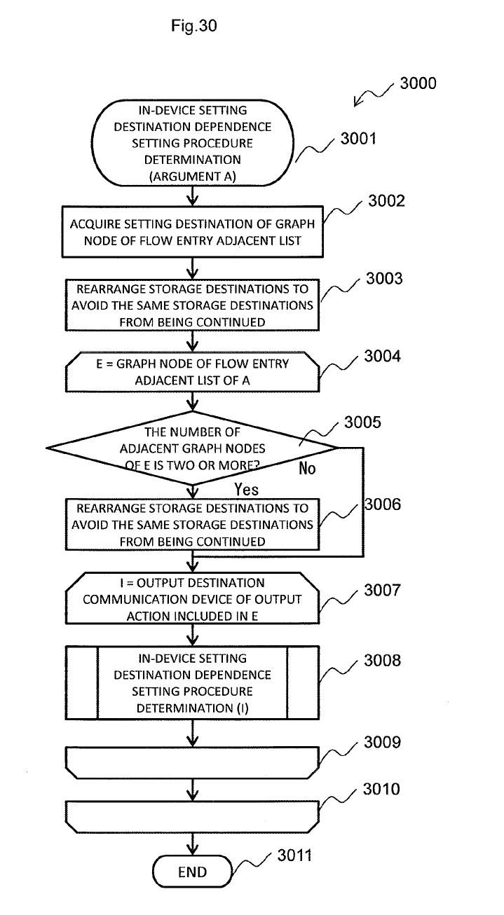

FIG. 30 is the flow chart 3000 of step 2903 of determining an in-device setting procedure depending on a setting destination in FIG. 29. Step 2903 is a recursive process, and takes a communication device A as an argument. The process is started from a start state 3001, and shifts to step 3002.

In step 3002, setting destinations of all the graph nodes in the flow entry adjacent list of the device A are acquired from the network setting data 400, and the process shifts to step 3003. In step 3003, on the basis of the setting destinations of the flow entry adjacent graph nodes acquired in step 3002, the order of the graph nodes are rearranged such that the same setting destinations (storage destinations) are not serial, and the process shifts to step 3004.

Step 3004 to step 3010 are repetitive processing (stored in the variable E) for a graph node of the flow entry adjacent list of the communication device A.

It is determined in step 3005 whether there are a plurality of adjacent graph nodes of the variable E. The process shifts to step 3006 when Yes is determined, shifts to step 3007 when No is determined.

In step 3006, on the basis of the setting destination of the adjacent graph node of the variable E acquired in step 3002, the order of the adjacent graph nodes is rearranged such that the same setting destinations (storage destinations) are not serial, and the process shifts to step 3007.

Step 3007 to step 3009 are repetitive processing (stored in the variable I), for an output destination communication device of an output action included in the variable E. The output destination communication device of the output action is acquired from the network configuration data 500. In step 3008, the variable I is designated as an argument, the flow chart 3000 of in-device setting destination dependence setting procedure determination is executed, and the process shifts to step 3009.

In step 3009, the process shifts to step 3010 when the repetitive processing is finished, and returns to step 3007 when the repetitive processing is not finished. In step 3010, the process shifts to step 3011 when the repetitive processing is finished, and returns to step 3004 when the repetitive processing is not finished. Step 3011 is an end state.

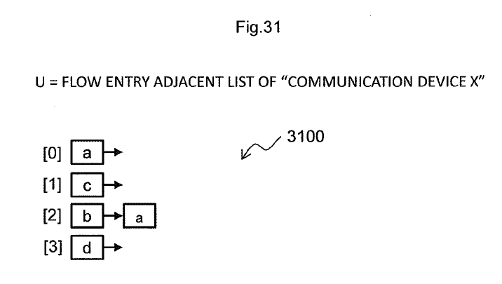

FIG. 31 shows an example of a flow entry adjacent list of the communication device X120 (1) after the flow chart 3000 of in-device setting destination dependence setting procedure determination step 606 in FIG. 6 is executed.

In this manner, on the basis of the flow chart 3000 of in-device setting destination dependence setting procedure determination, a setting procedure is created in consideration of an influence of a setting destination to avoid confliction in setting execution, and shortening of a setting execution time can be achieved.

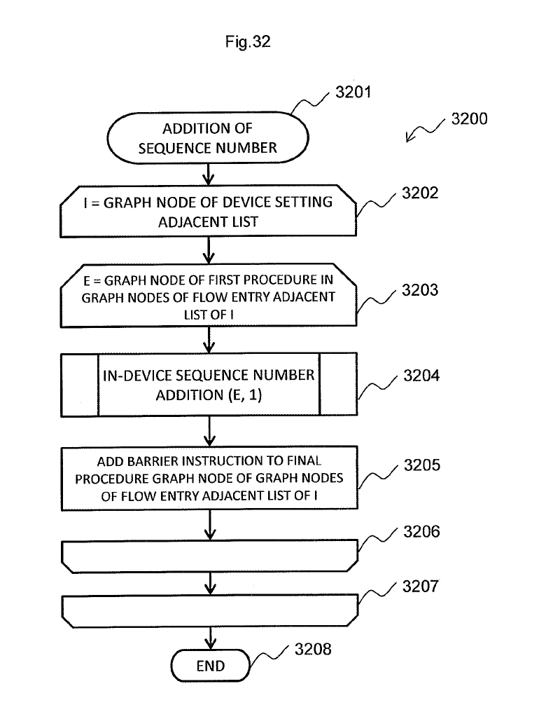

FIG. 32 is a flow chart 3200 of sequence number giving step 607 in FIG. 6. The process is started from a start state 3201, and shifts to step 3203. Step 3202 to step 3207 are repetitive processing (stored in the variable I) for a graph node of the device setting list 900. Step 3203 to step 3206 are repetitive processing (stored in the variable E) for a graph node a start procedure of the graph nodes in the flow entry adjacent list of the variable I. In step 3204, a flow chart 3300 of giving in-device sequence numbers (will be described later) is executed, and the process shifts to step 3205. In step 3205, a barrier instruction is added to the place next to the graph node of the final procedure of the variable I, and the process shifts to step 3206. In step 3206, the process shifts to step 3207 when the repetitive processing is finished, and returns to step 3203 when the repetitive processing is not finished. In step 3207, the process shifts to step 3208 when the repetitive processing is finished, and returns to step 3203 when the repetitive processing is not finished. The step 3208 is an end state.

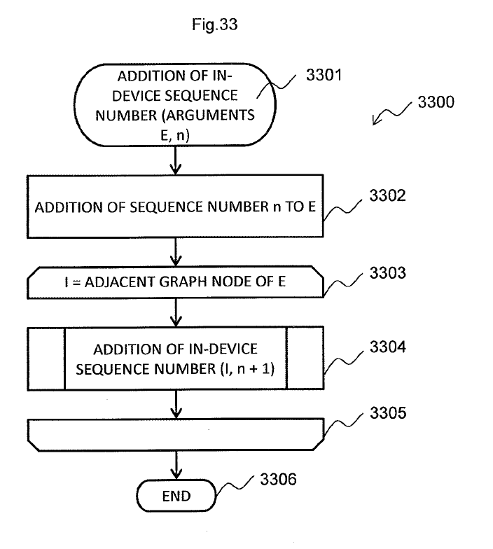

FIG. 33 is a flow chart 3300 of step 3204 of giving in-device sequence numbers in FIG. 32. The process of giving the in-device sequence numbers is a recursive process, and takes the flow entry E and sequence number n as arguments. The process is started from a start state 3301, and shifts to step 3302.

In step 3302, the sequence number n is given to the flow entry E, and the process shifts to step 3303. Step 3303 to step 3305 are repetitive processing (stored in the variable I) for an adjacent graph node of the flow entry E. In step 3304, the variable I and n+1 are designated as arguments, and the flow chart of giving in-device sequence numbers is executed again.

In step 3305, the flow shifts to step 3306 when the repetitive processing is finished, and returns to step 3303 when the repetitive processing is not finished. Step 3306 is an end state.

As described in FIG. 32 and FIG. 33, in the embodiment, sequence numbers representing setting orders are given to created setting procedures, respectively. In units of communication devices, instructions each of which requests a response of setting completion are added.

In this manner, the sequence numbers are given to the flow entries in units of communication devices 120 to make it possible to recognize that settings each having the same sequence number can be parallel executed in the communication device 120. For this reason, the parallel execution makes a setting execution time short.

The communication device 120 can independently execute setting by a correct setting procedure on the basis of the sequence number. For this reason, the control device 100 needs not check whether executions of settings of flow entries are sequentially finished. A time required to check completion of setting can be shortened. For example, since the communication device X120(1) of the network setting data 400 has four flow entries, if a configuration network is a delay WAN, for example, a network having a delay of 100 ms, in a conventional technique, 100 ms×2 (reciprocating)×4 800 ms are required to check completion of setting. However, in the embodiment, 100 ms×2 (reciprocating)=200 ms need only be required, and a setting execution time can be shortened.

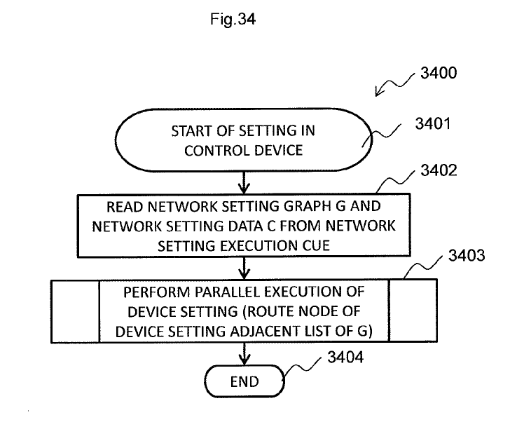

FIG. 34 is a flow chart of setting execution step 608 in FIG. 6 in the control device 100. The process is started from a start state 3401, and shifts to step 3402.

In step 3402, the network setting execution unit 105 reads a network setting graph G and network setting data C from the network setting execution queue 104 and shifts to step 3403.

In step 3403, the network setting execution unit 105 performs parallel execution of device setting and shifts to step 3404. Step 3404 is an end state.

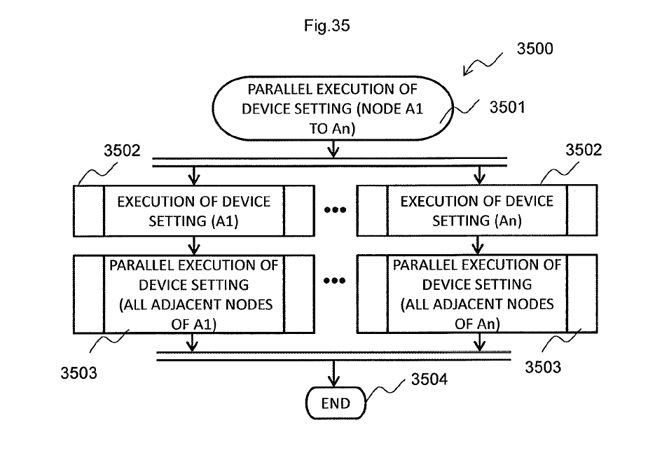

FIG. 35 is a flow chart 3500 of parallel execution step 609 of device setting in FIG. 6 in the network setting execution unit 105. The parallel execution of device setting is a recursive process, and takes a graph node of the device setting adjacent list (see FIG. 9) as an argument. The process is started from a start state 3501, and shifts to step 3502.

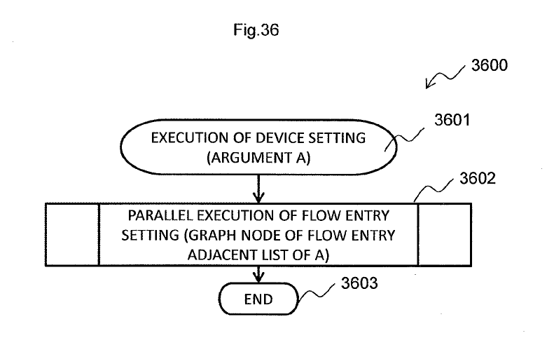

In step 3502, the network setting execution unit 105 takes, of the graph nodes of the device setting adjacent list, graph nodes An (n is a natural number, the maximum n is the number of graph nodes which are not adjacent to each other) which are not adjacent to each other as arguments to execute a flow chart 3600 (see FIG. 36) of executing device setting (will be described later) and shifts to step 3503.

Step 3503 is executed independently of step 3502 executed in parallel with step 3503. In step 3503, the network setting execution unit 105 takes all adjacent nodes of the graph nodes An as arguments to call parallel execution of device setting again and shifts to step 3504. Step 3504 is an end state.

FIG. 36 is a flow chart 3600 of execution step 3502 of the device setting in FIG. 35. The flow chart 3600 takes the device A as an argument. The process is started from a start state 3601, and shifts to step 3602. In step 3602, the network setting execution unit 105 executes parallel execution 3700 of flow entry setting (will be described later) and shifts to step 3603. Step 3603 is an end state.

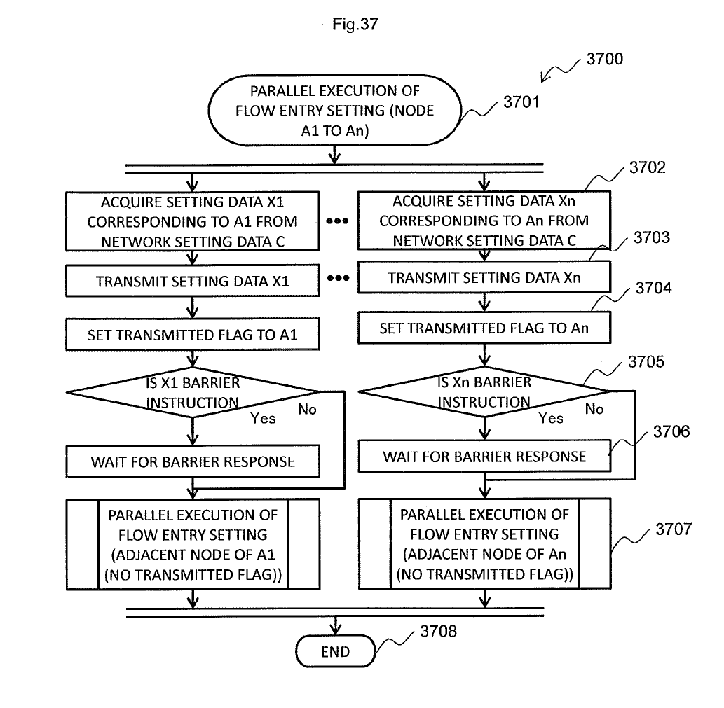

FIG. 37 is a flow chart 3700 of parallel execution step 3602 of flow entry setting in FIG. 36. The parallel execution of flow entry setting is a recursive process, and takes a graph node of the flow entry adjacent list as an argument. The process is started from a start state 3701, and shifts to step 3702.

Steps 3702 for the graph nodes An (n is a natural number, and the maximum n is the number of graph nodes which are not adjacent to each other) of the flow entries which are not adjacent to each other are executed in parallel with each other.

In step 3702, the network setting execution unit 105 acquires setting data Xn corresponding to the graph nodes An are acquired from the network setting data C and shifts to step 3703.

In step 3703, the network setting execution unit 105 transmits the setting data Xn to a target of the communication devices 120 and shifts to step 3704.

In step 3704, the network setting execution unit 105 sets transmitted flags to the graph nodes An and shifts to step 3705.

It is checked in step 3705 whether Xn is a barrier instruction. The network setting execution unit 105 shifts to step 3706 when Yes is determined and shifts to step 3707 when No is determined.

In step 3706, the network setting execution unit 105 waits until a barrier response is returned from the communication device 120 which transmits the barrier instruction and shifts to step 3707 when the barrier response is returned.

Step 3707 takes, of the adjacent nodes of the graph nodes An, a graph node to which the transmitted flag is not set as an argument to call parallel execution of flow entry setting, and the process shifts to step 3708. Step 3708 is an end state.

In the above embodiment, a storage destination of a setting included in network setting data in a communication device is detected. A setting procedure is created such that a plurality of settings included in new network settings can be simultaneously set in communication devices. For this purpose, the network setting execution unit 105 executes a setting on the basis of the network setting graph. In this manner, in units of devices and in units of flow entries in a device, settings can be parallel executed by a procedure which does not cause a failure in a network. For this reason, a setting execution time of the control device can be safely shortened. In addition, the network setting execution unit according to the embodiment executes settings to communication devices according to the created setting procedure. The network setting execution unit can be configured to wait for a response when the network setting execution unit transmits an instruction of requesting a response of completion of setting.

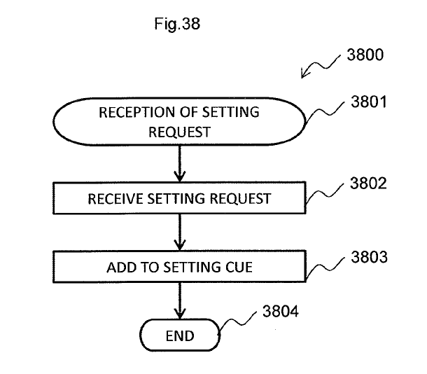

FIG. 38 is a setting request reception flow chart 3800 which is a part of setting process step 609 in FIG. 6 in the communication device 120. The process is started from a start state 3801, and shifts to step 3802.

In step 3802, the setting execution unit 122 receives a setting request from the control device 100 and shifts to step 3803.

In step 3803, the setting execution unit 122 stores a setting request in the setting queue 123 and shifts to step 3804. Step 3804 is an end state.

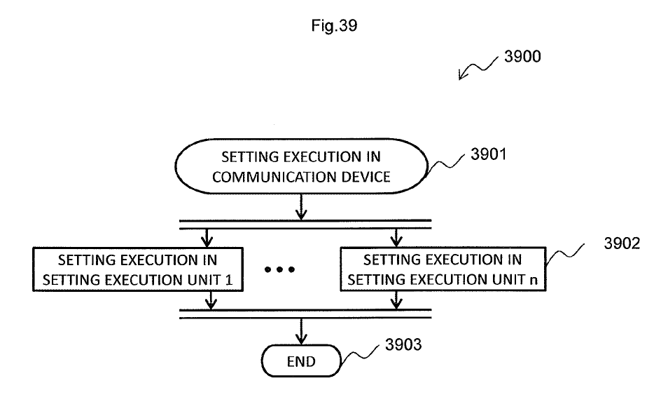

FIG. 39 is a flow chart 3900 of setting execution which is a part of setting process step 609 in FIG. 6 in the communication 120. The process is started from a start state 3901, and shifts to step 3902.

In step 3902, settings 4000 of n (n is a natural number) setting execution units (122 in FIG. 1) are executed in parallel with each other, and the process shifts to step 3903. In step 3903 is an end state.

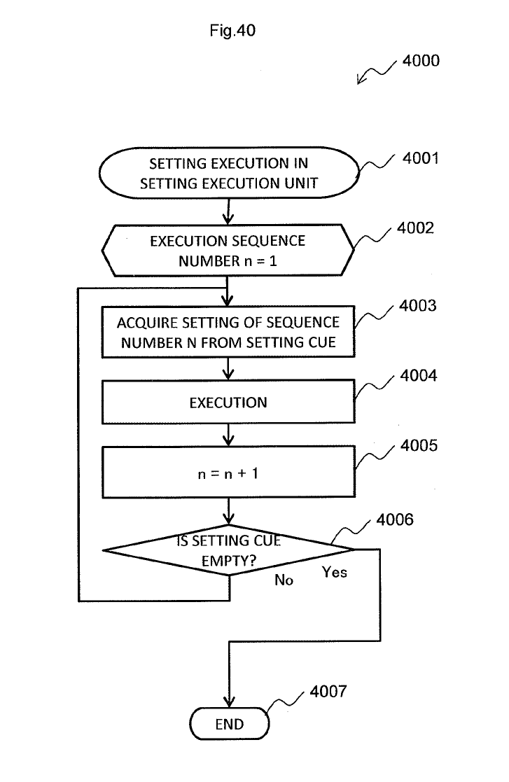

FIG. 40 is a flow chart of setting execution in the setting execution unit 122 which is a part of setting process step 609 in FIG. 6. The process is started from an initial state 4001, and shifts to step 4002.

In step 4002, the setting execution unit 122 initializes the execution sequence number n into 1 and shifts to step 4003.

In step 4003, the setting execution unit 122 acquires a setting of the sequence number n from the setting queue and shifts to step 4004.

In step 4004, the setting execution unit 122 stores the received setting in the setting storage unit and shifts to step 4005.

In step 4005, the setting execution unit 122 adds 1 to the execution sequence number n and shifts to step 4006.

In step 4006, the setting execution unit 122 checks whether the setting queue is empty. The setting execution unit 122 shifts to step 4007 when Yes is determined, and shifts to step 4003 when No is determined. Step 4007 is an end state.

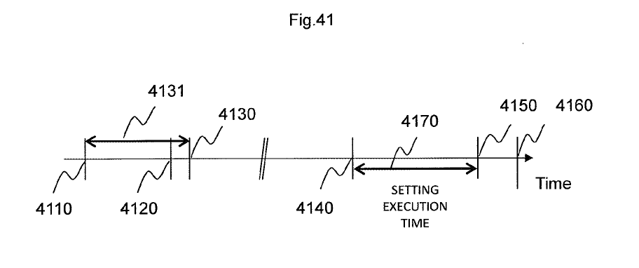

FIG. 41 shows a time line of network configuration changing in the embodiment of the present invention. Network design start time 4110 in FIG. 41 is time at which an operator examines setting contents of devices configurating a network on the basis of request specifications and starts creation of the network setting data 300 and the network configuration data 500 (step 602 in FIG. 6). When the operator finishes the design operation, the operator stores the network setting data 300 in the network setting queue 101 and stores the network configuration data 500 in the network configuration DB 102.

Setting procedure creating start time 4120 is time at which the network setting procedure creating unit 103 reads the network setting data 300 from the network setting queue 101 to start step 603 in FIG. 6.

Network design end time 4130 is time at which the network setting graph and the network setting data created with the network setting procedure creating unit 103 are stored in the network setting execution queue 104.

Up to now, network setting preparation 4131 is finished, and the system waits until scheduled network configuration change start time 4140. During the network setting preparation 4131, the network can be operated.

The network configuration change start time 4140 is setting start time described in the network setting data, and time at which the network setting execution unit 105 starts a setting described in the flow chart 3400 in FIG. 34.

Network examination start time 4150 is time at which examination to examine whether a network is correctly set after the setting described in the flow chart 3400 is finished. Service-in 4160 is time at which the operation of the network can be actually started after the examination.

According to the present invention, a setting procedures is created when a network is designed, a setting execution time 4170 in FIG. 41 is shortened to make it possible to change network configurations at a high speed. The setting execution time is a time in which a network which is being configured cannot be used. When the setting execution time 4170 is shortened, the utilization efficiency of network resources can be improved.

### Second Embodiment

The embodiment is to short a setting execution time in a control device according to the first embodiment. Referring to FIG. 1, configurations different from those of the first embodiment will be described below.

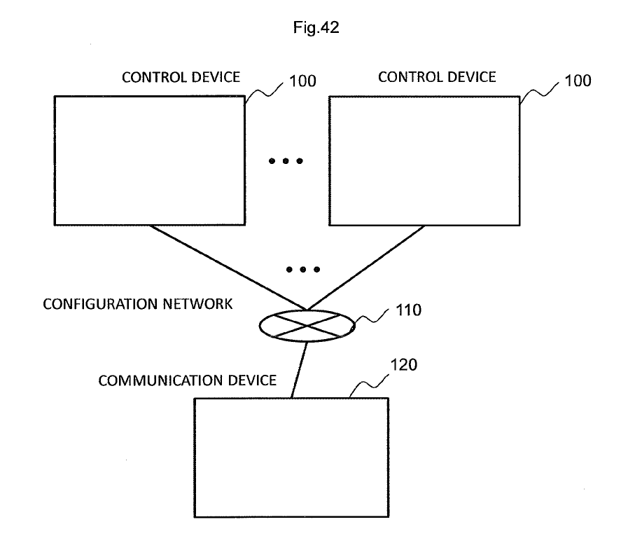

FIG. 42 is a block diagram showing a configuration of a network setting system according to the second embodiment. In the embodiment, the plurality of control devices are arranged. In the embodiment, the plurality of control devices 100 are connected to the configuration network 110 to make it possible to be communicate with each other. However, a network except for the configuration network 110 may be additionally connected as long as the networks communicate with each other.

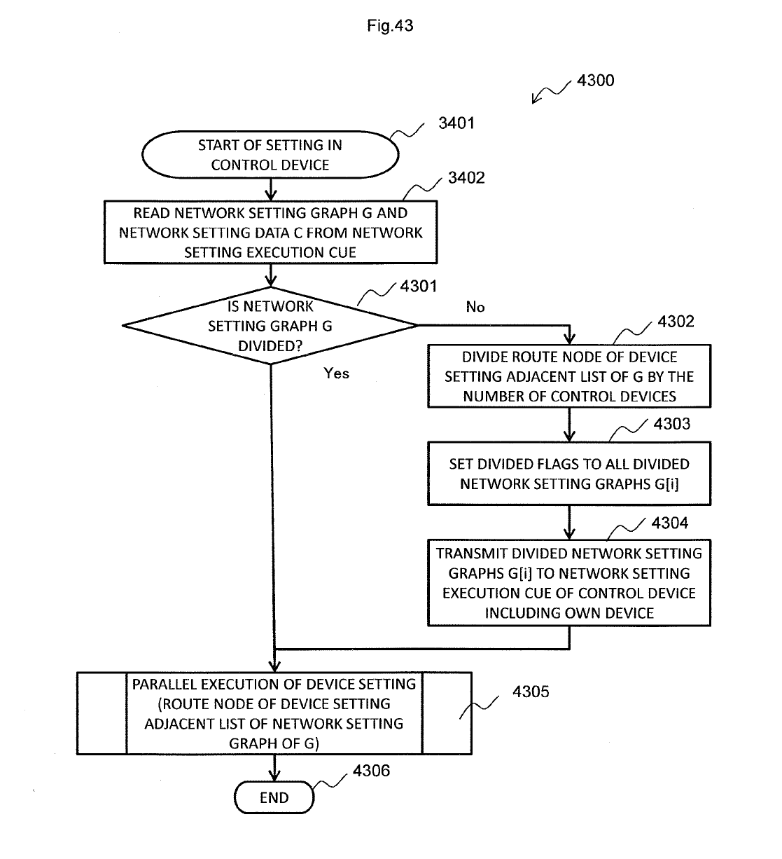

FIG. 43 is a flow chart 4300 of setting execution in the changed control devices. Step 3401 and step 3402 (see FIG. 34) are the same as those in the first embodiment.

In step 4301, the network setting execution unit 105 checks whether a divided setting flag is set to the read network setting graph. The network setting execution unit 105 shifts to step 4305 when Yes is determined and shifts to step 4302 when No is determined.

In step 4302, the network setting execution unit 105 divides the network setting graph G and shifts to step 4303. In the embodiment, a route node of a device setting list, i.e., a set of communication devices located on a most downstream of the network is divided by the number of control devices. When the set cannot be divided, the reminder may be allocated to an arbitrary control device. The division may be based on not only equal division, but also loads of the control device, and the number of communication devices managed by the control device. In step 4303, the network setting execution unit 105 sets the divided flags to the divided network setting graphs G[i] (i is a suffix), respectively and shifts to step 4304.

In step 4304, the network setting execution unit 105 stores the divided network setting graphs G[i] in a network setting execution queue of the control devices including the network setting execution unit 105 and shifts to step 4305.

In step 4305, the network setting execution unit 105 designates the divided network setting graphs G as arguments, executes parallel execution step of device setting, and shifts to step 4306. Step 4306 is an end state.

With the above change, network settings can be executed by the plurality of control devices 100 in parallel with each other, and a load of the control device decreases. For this reason, a setting execution time can be shortened.

In the embodiment, a function equivalent to the function configured with software can also be achieved with hardware such as an FPGA (Field Programmable Gate Array) or an ASIC (Application Specific Integrated Circuit). Such a mode is included in the scope of the invention.

The present invention is not limited to the embodiments described above, and includes various modifications. For example, a part of the configuration of a certain embodiment can be replaced with the configuration of the another embodiment, and the configuration of a certain embodiment can be added to the configuration of another embodiment. With respect to a part of the configuration of each of the embodiments, the configuration of another embodiment can be added, deleted, and replaced.

What is claimed is:

1. A network control device which includes an input device, an output device, a storage device, and a processing device, and is connected to at least one communication device through a network, and performs network setting in the communication device on the basis of network setting data input from the input device or stored in the storage device, wherein the processing device has a network setting procedure creating unit which creates a setting procedure of the network setting, and
the network setting procedure creating unit executes:
a function of detecting a connection relation of the communication device from network data input from the input device or stored in the storage device; and
a function of determining a setting order in unit of the communication device on the basis of the detected connection relation and the network setting data to create a setting procedure of new network setting.

2. The network control device according to claim 1, wherein
the network setting procedure creating unit executes
a function of detecting an inclusive relation between settings included in the network setting data,
on the basis of the detected inclusive relation, creates a setting order in the communication device.

3. The network control device according to claim 2, wherein
the network setting procedure creating unit
selects, of the created setting procedures of new network setting, the setting procedure which does not conflict with the set network setting input from the input device or stored in the storage device is selected.

4. The network control device according to claim 3, wherein
a storage destination of a setting included in the network setting data in the communication device is detected, and a setting procedure is created such that a plurality of settings included in the new network settings are simultaneously set to different storage destinations in the communication device.

5. The network control device according to claim 4, wherein a sequence number representing a setting order is given to the created setting procedure, and an instruction which requests a response of completion of setting is added in unit of the communication device.

6. The network control device according to claim 5, wherein
a network setting execution unit is included, according to the created setting procedure, the network setting execution unit executes setting to the communication device, and waits for a response when the instruction which requests a response of completion of setting is transmitted.

7. The network control device according to claim 1, wherein
the setting order in unit of the communication device, when a transmission side and a reception side of data are defined as upstream and downstream sides, respectively, is set from the downstream side.

8. The network setting system in which a control device and a communication device are connected through a network, wherein
the control device
includes an input device, an output device, a storage device, and a processing device, and performs network setting in the communication device on the basis of network setting data input from the input device or stored in the storage device, wherein
the processing device has a network setting procedure creating unit which creates a setting procedure of the network setting, and
the network setting procedure creating unit is a control device which executes:
a function of detecting a connection relation of the communication device from network configuration data input from the input device or stored in the storage device; and
a function of creating a setting order in unit of the communication device on the basis of the detected connection relation and the network setting data, and
creates a setting procedure of a new network setting on the basis of the setting order in unit of the communication device, and
the communication device
has a setting execution unit and a setting storage unit, the setting execution unit storing a setting received from the control device in the setting storage unit according to the setting order.

9. The network setting system according to claim 7, wherein
when the two or more control devices are used, the network setting execution units of the control devices which create the setting procedures divide a setting process in the other control device.

10. The network setting system according to claim 8, wherein
the network setting procedure creating unit
executes a function of detecting an inclusive relation between settings included in the network setting data, and
creates a setting procedure in the communication device on the basis of the detected inclusive relation.

11. The network setting system according to claim 10, wherein
the network setting procedure creating unit
selects, of the created setting procedure of new network setting, the setting procedure which does not conflict with the set network setting input from the input device or stored in the storage device.

12. The network setting system according to claim 11, wherein
a storage destination of a setting included in the network setting data in the communication device is detected, and a setting procedure is created such that a plurality of settings included in the new network setting can be simultaneously set in different storage destinations in the communication device, respectively.

13. The network setting system according to claim 12, wherein
a sequence number representing a setting order is given to the created setting procedure, and an instruction which requests a response of completion of setting is added in unit of the communication device.

14. The network setting system according to claim 13, wherein
a network setting execution unit is included, according to the created setting procedure, the network setting execution unit executes setting to the communication device, and waits for a response when the instruction which requests a response of completion of setting is transmitted.

15. The network setting system according to claim 8, wherein
the setting order in unit of the communication device, when a transmission side and a reception side of data are defined as upstream and downstream sides, respectively, is set from the downstream side.
